(19) United States
(12) Patent Application Publication
(10) Pub. No.: US 2025/0274298 A1
(43) Pub. Date: Aug. 28, 2025

(54) DATA PROCESSING METHOD AND APPARATUS BASED ON MULTIPLE BLOCKCHAINS, DEVICE, AND MEDIUM

(71) Applicant: Tencent Technology (Shenzhen) Company Limited, Shenzhen (CN)

(72) Inventor: Gengliang ZHU, Shenzhen (CN)

(73) Assignee: Tencent Technology (Shenzhen) Company Limited, Shenzhen (CN)

(21) Appl. No.: 19/209,240

(22) Filed: May 15, 2025

Related U.S. Application Data
(63) Continuation of application No. PCT/CN2023/123772, filed on Oct. 10, 2023.

(30) Foreign Application Priority Data
May 6, 2023 (CN) 202310505182.7

(51) Int. Cl. H04L 9/00; H04L 9/32

(52) U.S. Cl. CPC H04L 9/50; H04L 9/3213

(57) ABSTRACT

A data processing method based on multiple blockchains is disclosed, the multiple blockchains including a first blockchain and a second blockchain, and the method being performed by a computer device maintaining a first blockchain node in the first blockchain network and including: receiving an cross-chain asset transfer request, which includes a cross-chain asset transfer transaction used to instruct to transfer the to-be-transferred full-chain asset from the first blockchain to the second blockchain (S101); and transferring the full-chain asset accordingly.

### RELATED APPLICATION

This application claims priority to Chinese Patent Application No. 2023105051827, entitled “DATA PROCESSING METHOD AND APPARATUS BASED ON MULTIPLE BLOCKCHAINS, DEVICE, AND MEDIUM” and filed on May 6, 2023 and PCT/CN2023/123772 with the same title and filed on Oct. 10, 2023, which is incorporated herein by reference in its entirety.

### FIELD OF THE TECHNOLOGY

This application relates to the field of blockchain technologies, and in particular, to a data processing method and apparatus based on multiple blockchains, a device, and a medium.

### BACKGROUND OF THE DISCLOSURE

Currently, a digital asset (for example, a digital asset P) may be transferred from a blockchain A to a blockchain B. However, in a process of transferring the digital asset P from the blockchain A to the blockchain B, a new mapping asset (for example, a digital asset P′) having the same asset content as that of the digital asset P needs to be determined on the blockchain B according to an asset determining rule on the blockchain B.

In practice because blockchain A is independent of blockchain B and an asset determining rule on blockchain A substantially differs from the asset determining rule on blockchain B, the mapping asset (for example, the digital asset P′) finally determined on blockchain B and the digital asset P transferred out of blockchain A are different digital assets, causing security risks.

### SUMMARY

According to embodiments of this disclosure, a data processing method and apparatus based on multiple blockchains, a device, and a medium are provided.

According to one aspect, this disclosure provides a data processing method based on multiple blockchains, the multiple blockchains including a first blockchain and a second blockchain, the first blockchain corresponding to a first blockchain network, the second blockchain corresponding to a second blockchain network, the first blockchain network being independent of the second blockchain network, and the method being performed by a computer device maintaining a first blockchain node in the first blockchain network and including:
obtaining a full-chain asset transfer request sent by a first service object for a service transaction, invoking a target full-chain service contract on the first blockchain when it is determined, based on the full-chain asset transfer request, that the service transaction is a cross-chain asset transfer transaction, and using a full-chain asset associated with the cross-chain asset transfer transaction as a to-be-transferred full-chain asset, the cross-chain asset transfer transaction being used to instruct to transfer the to-be-transferred full-chain asset from the first blockchain to the second blockchain;
invoking a full-chain contract protocol in the target full-chain service contract, to determine a target remote contract address bound to the target full-chain service contract, the full-chain contract protocol being determined based on a full-chain contract protocol interface provided by a full-chain service parent contract on the first blockchain, and a target remote full-chain service contract corresponding to the target remote contract address being a full-chain service contract that is on the second blockchain and integrated with the full-chain contract protocol; and
transmitting, by using an off-chain cross-chain service device, a cross-chain asset reconstruction transaction corresponding to a cross-chain asset transfer event to a second blockchain node in the second blockchain network when generating, based on the target remote contract address and the to-be-transferred full-chain asset, the cross-chain asset transfer event corresponding to the cross-chain asset transfer transaction, so that the second blockchain node determines, on the second blockchain based on the cross-chain asset reconstruction transaction, the target remote full-chain service contract corresponding to the target remote contract address, and invokes the target remote full-chain service contract to generate, on the second blockchain, a full-chain mapping asset corresponding to the to-be-transferred full-chain asset, asset data information of the full-chain mapping asset being the same as asset data information of the to-be-transferred full-chain resource.

According to another aspect, this disclosure provides a data processing method based on multiple blockchains, the multiple blockchains including a first blockchain and a second blockchain, the first blockchain corresponding to a first blockchain network, the second blockchain corresponding to a second blockchain network, the second blockchain network being independent of the first blockchain network, and the method being performed by a computer device maintaining a second blockchain node in the second blockchain network and including:
obtaining a cross-chain asset reconstruction transaction, the cross-chain asset reconstruction transaction corresponding to a cross-chain asset transfer event, the cross-chain asset transfer event being sent by a first blockchain node in the first blockchain network by using an off-chain cross-chain service device, the cross-chain asset transfer event being an event that corresponds to a cross-chain asset transfer transaction and that is generated by the first blockchain node based on a target remote contract address bound to a target full-chain service contract and a to-be-transferred full-chain asset, the target remote contract address being obtained by the first blockchain node by using a full-chain contract protocol in the target full-chain service contract, the to-be-transferred full-chain asset being a full-chain asset that is associated with the cross-chain asset transfer transaction and that is determined by invoking the target full-chain service contract when the first blockchain node obtains a full-chain asset transfer request sent by a first service object for a service transaction and determines, based on the full-chain asset transfer request, that the service transaction is a cross-chain asset transfer transaction, the target full-chain service contract being a full-chain service contract that is on the first blockchain and integrated with the full-chain contract protocol, and a remote full-chain service contract corresponding to the target remote contract address being a full-chain service contract that is on the second blockchain and integrated with the full-chain contract protocol; and
determining, on the second blockchain based on the cross-chain asset reconstruction transaction, the target remote full-chain service contract corresponding to the target remote contract address, and invoking the target remote full-chain service contract to generate, on the second blockchain, a full-chain mapping asset corresponding to the to-be-transferred full-chain asset, asset data information of the full-chain mapping asset being the same as asset data information of the target full-chain asset.

According to still another aspect, this disclosure provides a data processing apparatus based on multiple blockchains, the multiple blockchains including a first blockchain and a second blockchain, a blockchain network corresponding to the first blockchain being a first blockchain network, a blockchain network corresponding to the second blockchain being a second blockchain network, the first blockchain network being independent of the second blockchain network, and the apparatus being run on a first blockchain node in the first blockchain network and including:
a full-chain asset obtaining module, configured to: obtain a full-chain asset transfer request sent by a first service object for a service transaction, invoke a target full-chain service contract on the first blockchain when it is determined, based on the full-chain asset transfer request, that the service transaction is a cross-chain asset transfer transaction, and use a full-chain asset associated with the cross-chain asset transfer transaction as a to-be-transferred full-chain asset, the cross-chain asset transfer transaction being used to instruct to transfer the to-be-transferred full-chain asset from the first blockchain to the second blockchain;
a contract address determining module, configured to: invoke a full-chain contract protocol in the target full-chain service contract, to determine a target remote contract address bound to the target full-chain service contract, the full-chain contract protocol being determined based on a full-chain contract protocol interface provided by a full-chain service parent contract on the first blockchain, and a target remote full-chain service contract corresponding to the target remote contract address being a full-chain service contract that is on the second blockchain and integrated with the full-chain contract protocol; and
a transfer event generation module, configured to transmit, by using an off-chain cross-chain service device, a cross-chain asset reconstruction transaction corresponding to a cross-chain asset transfer event to a second blockchain node in the second blockchain network when generating, based on the target remote contract address and the to-be-transferred full-chain asset, the cross-chain asset transfer event corresponding to the cross-chain asset transfer transaction, so that the second blockchain node determines, on the second blockchain based on the cross-chain asset reconstruction transaction, the target remote full-chain service contract corresponding to the target remote contract address, and invokes the target remote full-chain service contract to generate, on the second blockchain, a full-chain mapping asset corresponding to the to-be-transferred full-chain asset, asset data information of the full-chain mapping asset being the same as asset data information of the to-be-transferred full-chain resource.

According to still another aspect, this disclosure provides a data processing apparatus based on multiple blockchains, the multiple blockchains including a first blockchain and a second blockchain, a blockchain network corresponding to the first blockchain being a first blockchain network, a blockchain network corresponding to the second blockchain being a second blockchain network, the second blockchain network being independent of the first blockchain network, and the apparatus being run on a second blockchain node in the second blockchain network and including:
a reconstruction transaction obtaining module, configured to obtain a cross-chain asset reconstruction transaction, the cross-chain asset reconstruction transaction corresponding to a cross-chain asset transfer event, the cross-chain asset transfer event being sent by a first blockchain node in the first blockchain network by using an off-chain cross-chain service device, the cross-chain asset transfer event being an event that corresponds to a cross-chain asset transfer transaction and that is generated by the first blockchain node based on a target remote contract address bound to a target full-chain service contract and a to-be-transferred full-chain asset, the target remote contract address being obtained by the first blockchain node by using a full-chain contract protocol in the target full-chain service contract, the to-be-transferred full-chain asset being a full-chain asset that is associated with the cross-chain asset transfer transaction and that is determined by invoking the target full-chain service contract when the first blockchain node obtains a full-chain asset transfer request sent by a first service object for a service transaction and determines, based on the full-chain asset transfer request, that the service transaction is a cross-chain asset transfer transaction, the target full-chain service contract being a full-chain service contract that is on the first blockchain and integrated with the full-chain contract protocol, and a remote full-chain service contract corresponding to the target remote contract address being a full-chain service contract that is on the second blockchain and integrated with the full-chain contract protocol; and
a mapping asset generation module, configured to: determine, on the second blockchain based on the cross-chain asset reconstruction transaction, the target remote full-chain service contract corresponding to the target remote contract address, and invoke the target remote full-chain service contract to generate, on the second blockchain, a full-chain mapping asset corresponding to the to-be-transferred full-chain asset, asset data information of the full-chain mapping asset being the same as asset data information of the target full-chain asset.

According to still another aspect, this disclosure provides a computer device, including a memory and a processor, the memory having computer-readable instructions stored therein, and the processor being configured to execute the computer-readable instructions to perform the method according to any one of the embodiments of this disclosure.

According to still another aspect, this disclosure provides a computer-readable storage medium, having computer-readable instructions stored therein, when executed by a processor, the computer-readable instructions performing the method according to any one of the embodiments of this disclosure.

According to still another aspect, this disclosure provides a computer program product, including computer-readable instructions, when executed by a processor, the computer-readable instructions performing the method according to any one of the embodiments of this disclosure.

Details of one or more embodiments of this disclosure are provided in the accompanying drawings and descriptions below. Other features and advantages of this disclosure become clear with reference to the specification, the accompanying drawings, and the claims.

### BRIEF DESCRIPTION OF THE DRAWINGS

To describe the technical solutions in the embodiments of this disclosure more clearly, the following briefly describes the accompanying drawings required for describing the embodiments or the related art. Apparently, the accompanying drawings in the following descriptions show merely some embodiments of this application, and a person of ordinary skill in the art may still derive other drawings from these disclosed accompanying drawings without creative efforts.

FIG. 1 is a schematic diagram of a hierarchical structure of a blockchain network according to an embodiment of this disclosure;

FIG. 2 is a schematic diagram of a data processing scenario based on multiple blockchains according to an embodiment of this disclosure;

FIG. 3 is a schematic diagram of a data processing scenario based on multiple blockchains according to an embodiment of this disclosure;

FIG. 4 is a first schematic flowchart of a data processing method based on multiple blockchains according to an embodiment of this disclosure;

FIG. 5 is a schematic diagram of a cross-chain asset transfer scenario according to an embodiment of this disclosure;

FIG. 6 is a second schematic flowchart of a data processing method based on multiple blockchains according to an embodiment of this disclosure;

FIG. 7 is a schematic diagram of a contract update scenario according to an embodiment of this disclosure;

FIG. 8 is a third schematic flowchart of a data processing method based on multiple blockchains according to an embodiment of this disclosure;

FIG. 9 is a schematic interaction diagram of data processing based on multiple blockchains according to an embodiment of this disclosure;

FIG. 10 is a schematic interaction diagram of contract update according to an embodiment of this disclosure;

FIG. 11 is a first schematic structural diagram of a data processing apparatus based on multiple blockchains according to an embodiment of this disclosure;

FIG. 12 is a second schematic structural diagram of a data processing apparatus based on multiple blockchains according to an embodiment of this disclosure;

FIG. 13 is a schematic structural diagram of a computer device according to an embodiment of this disclosure; and

FIG. 14 is a schematic diagram of a data processing system based on multiple blockchains according to an embodiment of this disclosure.

### DESCRIPTION OF EMBODIMENTS

The technical solutions in the embodiments of this disclosure are clearly and completely described in the following with reference to the accompanying drawings in the embodiments of this disclosure. Apparently, the described embodiments are merely some rather than all of the embodiments of this disclosure. All other embodiments obtained by a person of ordinary skill in the art based on the embodiments of this disclosure without creative efforts shall fall within the protection scope of this disclosure.

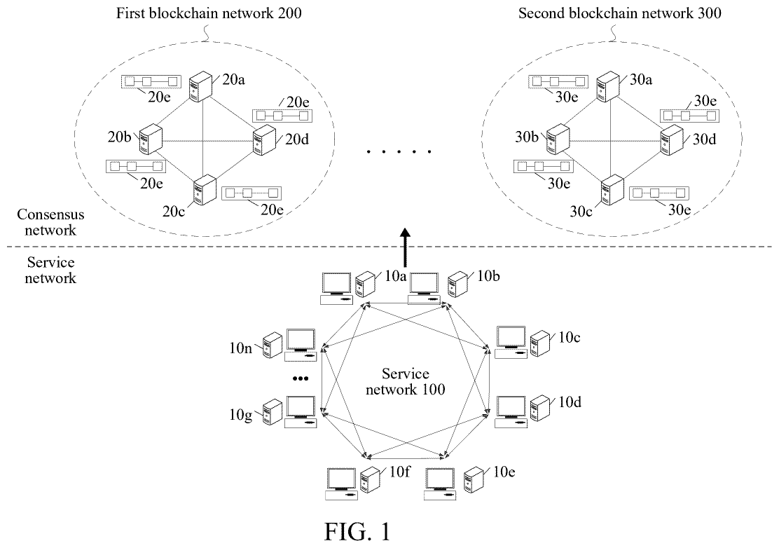

FIG. 1 is a schematic diagram of a hierarchical structure of a blockchain network according to an embodiment of this disclosure. The hierarchical structure shown in FIG. 1 is applied to a blockchain data system, for example, which may be a blockchain digital asset system. The blockchain digital asset system may be a system including a multi-blockchain network. The digital asset may be a digital collection, an electronic bill, or the like. The digital asset may be transferred and circulated in the multi-blockchain network, that is, full-chain circulation of the digital asset may be implemented in the multi-blockchain network. In this case, the digital asset may be referred to as a full-chain asset. A blockchain network corresponding to the blockchain digital asset system includes a service network and multiple blockchain networks (that is, consensus networks). The service network is located in a public network, and the blockchain network is located in a private network (for example, deployed in a private cloud). As shown in FIG. 1, the service network may be a service network 100 shown in FIG. 1, and the multiple blockchain networks may specifically include a first blockchain network 200 and a second blockchain network 300 shown in FIG. 1.

Multiple service nodes are deployed in the service network 100 shown in FIG. 1. The multiple service nodes may specifically include a service node 10a, a service node 10b, . . . , and a service node 10n shown in FIG. 1. A quantity of service nodes deployed in the service network 100 is not limited herein. As a service requirement changes, a quantity of service nodes may constantly change. A service node in the service network 100 does not need to perform bookkeeping. In addition, as shown in FIG. 1, all service nodes running in the service network 100 may access one or more of the multiple consensus networks through network communication. A quantity of consensus networks accessed by service objects through corresponding service nodes is not limited herein. The consensus networks may also exchange data with each other through network communication.

Multiple blockchain nodes are deployed in the first blockchain network 200 shown in FIG. 1. The multiple blockchain nodes may specifically include a blockchain node 20a, a blockchain node 20b, a blockchain node 20c, and a blockchain node 20d shown in FIG. 1. A quantity of blockchain nodes deployed in the first blockchain network 200 is not limited herein. As a service requirement changes, the quantity of blockchain nodes herein may constantly change, and may be 3 or more. In addition, as shown in FIG. 1, for the multiple blockchain nodes running in the first blockchain network 200, a blockchain that is jointly maintained is specifically a blockchain 20e shown in FIG. 1.

Accordingly, multiple blockchain nodes are deployed in the second blockchain network 300 shown in FIG. 1. The multiple blockchain nodes may specifically include a blockchain node 30a, a blockchain node 30b, a blockchain node 30c, and a blockchain node 30d shown in FIG. 1. A quantity of blockchain nodes deployed in the second blockchain network 300 is not limited herein. As a service requirement changes, the quantity of blockchain nodes herein may constantly change, and may be 3 or more. In addition, as shown in FIG. 1, for the multiple blockchain nodes running in the second blockchain network 300, a blockchain that is jointly maintained is specifically a blockchain 30e shown in FIG. 1.

For ease of understanding, in this embodiment of this disclosure, the first blockchain network 200 located in the blockchain digital asset system may be referred to as a first blockchain network, the blockchain 20e maintained by the first blockchain network 200 is referred to as a first blockchain, and a blockchain node in the first blockchain network 200 is referred to as a first blockchain node. The second blockchain network 300 located in the blockchain digital asset system may be referred to as a second blockchain network, the blockchain 30e maintained by the second blockchain network 300 is referred to as a second blockchain, and a blockchain node in the second blockchain network 300 is referred to as a second blockchain node. The first blockchain network and the second blockchain network are independent of each other, and the first blockchain and the second blockchain are independent of each other. The first blockchain and the second blockchain may be blockchains constructed in any service scenario. The blockchain digital asset system may include a multi-blockchain network. The multi-blockchain network may include multiple blockchain networks independent of each other, and each blockchain network is configured to maintain a respective blockchain (that is, a service chain). A quantity of blockchain networks in the multi-blockchain network (a quantity of service chains in the multiple blockchains) is not limited herein. As a service requirement changes, the quantity of blockchain networks herein may constantly change. A digital asset transfer process in the multiple blockchains is described herein only by using an example in which the multiple blockchains include the first blockchain and the second blockchain.

In addition, a blockchain of the multiple blockchains may be any type of blockchain, for example, may be a blockchain of a layer 1 type or a blockchain of a layer 2 type. This is not limited herein. The layer 1 refers to an underlying blockchain, and the layer 1 blockchain is an underlying basis for building various layer 2 networks. Functions of the layer 1 include: a node manager network (used for protecting and verifying a network), a block producer network, a blockchain itself, historical transaction data, and a network consensus mechanism. The layer 2 refers to a blockchain that is established on a layer 1 public chain and that is in a layer 2 blockchain network for optimizing processing transaction and calculation.

The blockchain involved in the embodiments of this disclosure is a novel application mode of computer technologies such as distributed data storage, point-to-point transmission, a consensus mechanism, and an encryption algorithm, and is mainly configured to organize data in chronological order and encrypt the data into a ledger, to perform verification on, store, and update the data while preventing the data from being tampered with or forged. The blockchain is essentially a decentralized database. Every node in the database stores the same blockchain.

In the blockchain digital asset system, a blockchain node may be responsible for consensus in a blockchain network on which a corresponding blockchain is located. That is, the blockchain node may be a consensus node of a blockchain network on which a corresponding blockchain is located. For any blockchain network of the two blockchain networks, a specific process of writing transaction data in the blockchain network into a corresponding blockchain ledger (for example, a distributed database) may be: A service client sends transaction data to a service node. Then, the transaction data is transferred between service nodes in a service network in the blockchain network until a blockchain node (for example, the blockchain node 20b in the first blockchain network 200) in the blockchain network receives the transaction data. In this case, the blockchain node (for example, the blockchain node 20b in the first blockchain network 200) further packages the transaction data into a block, to facilitate subsequent consensus with another blockchain node, so that after the consensus is reached, the blockchain node may write the block on which the consensus is reached into a distributed database of a blockchain network (for example, the first blockchain network 200) in which the blockchain node is located. In some embodiments, the service client may be an application program having a function of displaying data information such as a text, an image, an audio, and a video, such as a payment client, an entertainment client (for example, a game client), a multimedia client (for example, a video client), a smart home client, or a browser in a blockchain.

In the embodiments of this disclosure, after the consensus is reached, a block carrying the transaction data and multiple other blocks associated with the block may be written into the distributed database in parallel through a storage layer of a blockchain network (for example, the first blockchain network 200) in which the blockchain node is located, so that limitation of the blockchain structure of the blockchain can be eliminated from the root, which can effectively improve the data storage efficiency.

In the blockchain digital asset system, a smart contract may be deployed on a blockchain of a blockchain network. The smart contract in the blockchain digital asset system may be understood as code executed by blockchain nodes. Any logic can be executed based on the smart contract, and a result can be obtained. For example, a service object (for example, a user) can initiate a transaction service request (for example, a full-chain asset transfer request for a cross-chain asset transfer transaction) through a service client, to invoke a smart contract (for example, a target full-chain service contract for the cross-chain asset transfer transaction) already deployed on a blockchain (for example, the blockchain 20e) of a corresponding blockchain network (for example, the first blockchain network 200).

Specifically, a service node in a service network may send the transaction service request to a blockchain node (for example, the blockchain node 20a shown in FIG. 1) in the blockchain network, to perform, through a blockchain entrance of the blockchain network, identity authentication on the service object sending the transaction service request. When the identity authentication succeeds, the transaction service request sent by the service object is allowed to be sent to another blockchain node (for example, the blockchain node 20b shown in FIG. 1) in the blockchain network, to invoke smart contracts run in the blockchain nodes (for example, the blockchain node 20a and the blockchain node 20b shown in FIG. 1) to execute a transaction service requested by the service object.

One or more smart contracts may be deployed on the blockchain (for example, the blockchain 20e) of the blockchain network (for example, the first blockchain network 200). The smart contracts may be distinguished by contract invocation addresses (also referred to as contract addresses), contract identities (ID), or contract names. Moreover, the transaction service request initiated by the service client may also carry a contract invocation address, a contract identity, or a contract name of a smart contract, to specify the smart contract that needs to be run.

In the blockchain digital asset system, a point-to-point (P2P) network may be formed between any two blockchain nodes in any blockchain network (for example, the first blockchain network 200 or the second blockchain network 300). The P2P network may use a P2P protocol. The P2P protocol is an application layer protocol run over a transmission control protocol (TCP) protocol. Any device, such as a server or a terminal, may be added to a distributed system to become a blockchain node. Each blockchain node may include a hardware layer, an intermediate layer, an operating system layer, and an application layer.

In the embodiments of this disclosure, for any object (for example, an entity object such as any personal user, any enterprise, or any institution) accessing the blockchain network, a blockchain node may be configured. Therefore, in the service network 100 shown in FIG. 1, the service node 10a, the service node 10b, the service node 10c, the service node 10d, . . . , and the service node 10n may respectively have a one-to-one correspondence with corresponding objects requiring to access the blockchain network.

Because each entity object may correspond to one blockchain node, in the embodiments of this disclosure, for example, the entity object is the enterprise (that is, the foregoing enterprise). In this case, blockchain nodes associated with enterprises may be the same blockchain node (for example, the service node 10c shown in FIG. 1 may exchange data with service terminals corresponding to multiple enterprises, to transfer a digital asset). For example, in the blockchain digital asset system, services (for example, a digital asset transfer service) requested by a first service object may be collectively referred to as a transaction service. When the enterprise requests cross-chain transfer of a digital asset through the first blockchain network (for example, the first blockchain network 200), the enterprise can exchange data with a blockchain node (for example, the blockchain node 20b) in the first blockchain network 200 through the service node 10c shown in FIG. 1, to request completion of the corresponding transaction to transfer the to-be-transferred digital asset to the second blockchain network (for example, the second blockchain network 300).

When receiving a transaction service request, a service node associated with a first service object may forward, to an associated blockchain node in the first blockchain network, the transaction service request initiated by the first service object, to verify, by using the associated blockchain node in the first blockchain network, legality of the transaction service request initiated by the first service object. In this way, the associated blockchain node in the first blockchain network may process the transaction service when legality verification succeeds.

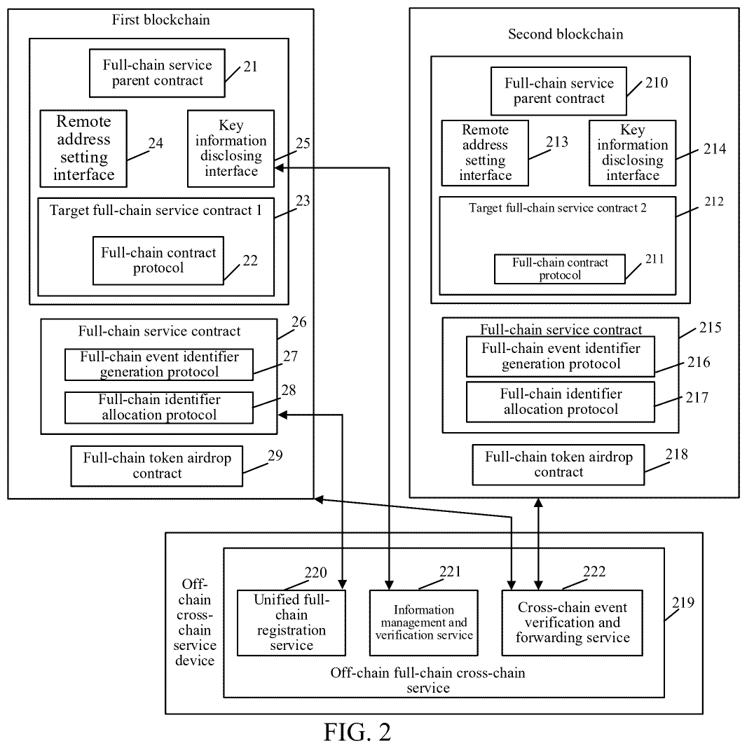

For ease of understanding, further, FIG. 2 is a schematic diagram of a data processing scenario based on multiple blockchains according to an embodiment of this disclosure. The blockchain digital asset system includes a first blockchain, a second blockchain, and an off-chain cross-chain service device. A full-chain service parent contract 21 (also referred to as a full-chain service protocol base contract) is deployed on the first blockchain. The full-chain service parent contract provides a full-chain contract protocol interface. A full-chain contract protocol 22 provided by the full-chain service parent contract may be obtained through the full-chain contract protocol interface. The full-chain contract protocol may provide a unified asset transfer rule. A target full-chain service contract 1 (23) for performing cross-chain asset transfer may be deployed on the first blockchain by using the full-chain service parent contract. The target full-chain service contract 1 is integrated with the full-chain contract protocol 23. In addition, the full-chain service parent contract on the first blockchain may further provide a remote address setting interface 24 and a key information disclosing interface 25. The remote address setting interface is configured to set a remote contract address corresponding to the target full-chain service contract 1. The remote contract address bound to the target full-chain service contract 1 may be used to indicate a full-chain service contract that corresponds to the target full-chain service contract 1 and that is on the second blockchain (for the target full-chain service contract 1 on the first blockchain, a full-chain service contract that corresponds to the target full-chain service contract 1 and that is on the second blockchain is a target remote full-chain service contract 1 corresponding to the target full-chain service contract 1, that is, a target full-chain service contract 2 is a target remote full-chain service contract 1 corresponding to the target full-chain service contract 1). The key information disclosing interface is configured to disclose node port information associated with the target full-chain service contract 1 on the first blockchain, to perform security verification. In addition, a full-chain service contract 26 may be further deployed on the first blockchain. The full-chain service contract may include a full-chain event identifier generation protocol 27 and a full-chain identifier allocation protocol 28. The full-chain event identifier generation protocol may be used to generate a unique full-chain event identifier when a cross-chain asset transfer event is generated. The full-chain identifier allocation protocol may be used to perform an initialization operation on a blockchain, such as allocation of a unique full-chain blockchain identifier. In addition, a full-chain token airdrop contract 29 may be deployed on the first blockchain, and is used to synchronously perform cross-chain token transfer when the digital asset is transferred.

Accordingly, the same full-chain service parent contract 210 (also referred to as a full-chain service protocol base contract) is deployed on the second blockchain. The full-chain service parent contract provides a full-chain contract protocol interface. A full-chain contract protocol 211 provided by the full-chain service parent contract may be obtained through the full-chain contract protocol interface. The full-chain contract protocol 211 may provide a unified asset transfer rule. A target full-chain service contract 2 (212) for performing cross-chain asset transfer may be deployed on the second blockchain by using the full-chain service parent contract. The target full-chain service contract 2 is integrated with the full-chain contract protocol. In addition, the full-chain service parent contract on the second blockchain may further provide a remote address setting interface 213 and a key information disclosing interface 214. The remote address setting interface is configured to set a remote contract address corresponding to the target full-chain service contract 2. The remote contract address bound to the target full-chain service contract 2 may be used to indicate a full-chain service contract that corresponds to the target full-chain service contract 2 and that is on the first blockchain (for the target full-chain service contract 2 on the second blockchain, a full-chain service contract that corresponds to the target full-chain service contract 2 and that is on the first blockchain is a target remote full-chain service contract 2 corresponding to the target full-chain service contract 2, that is, a target full-chain service contract 1 is a target remote full-chain service contract 2 corresponding to the target full-chain service contract 2). The key information disclosing interface is configured to disclose node port information associated with the target full-chain service contract 2 on the second blockchain, to perform security verification. In addition, a full-chain service contract 215 may be further deployed on the second blockchain. The full-chain service contract may include a full-chain event identifier generation protocol 216 and a full-chain identifier allocation protocol 217. The full-chain event identifier generation protocol may be used to generate a unique full-chain event identifier when a cross-chain asset transfer event is generated. The full-chain identifier allocation protocol may be used to perform an initialization operation on a blockchain, such as allocation of a unique full-chain blockchain identifier. In addition, a full-chain token airdrop contract 218 may be deployed on the second blockchain, and is used to synchronously perform cross-chain token transfer when the digital asset is transferred.

Related services deployed on the chain are as follows: The full-chain service parent contract may provide a unified standard full-chain contract protocol interface, a method for obtaining a unique full-chain blockchain identifier of a service chain of multiple blockchains, a method for obtaining a unique full-chain event identifier of an event corresponding to a service transaction in multiple blockchains, and the like, to ensure security of cross-chain transfer of a full-chain asset. The target full-chain service contract integrated with the full-chain contract protocol provided by the full-chain service parent contract may be separately deployed on each service chain in advance, to execute a cross-chain asset transfer transaction. The target full-chain service contract may perform logic such as initialization of a blockchain identifier of a service chain and generation of an asset identifier and an event identifier by using an off-chain full-chain cross-chain service. The full-chain token airdrop contract may provide an airdrop service of a basic token. When a full-chain asset needs to be transferred across chains, after the transfer, some basic tokens need to be obtained from a contract address corresponding to a target chain (to help continue to submit a service transaction on the target chain to operate the full-chain asset). When the target full-chain service contract is used to execute the cross-chain asset transfer transaction, the full-chain token airdrop contract may be invoked, and the full-chain token airdrop contract is used to pay airdrop fees, to complete token airdrop after the cross-chain transfer. The full-chain service parent contract is a parent contract of all target full-chain service contracts. That is, the target full-chain service contract on each service chain needs to be integrated with the full-chain asset protocol indicated by a full-chain asset protocol interface provided by the full-chain service parent contract, so that standard logic of cross-chain transfer of a full-chain asset may be implemented by using the target full-chain service contract. In addition, the full-chain service parent contract provides a remote address setting interface, and the remote address setting interface may be configured to bound a remote contract address to a target full-chain service contract on each service chain. The full-chain service parent contract further provides a key information disclosing interface, and the key information disclosing interface may be configured to disclose node port information involved when the target full-chain service contract is used to perform cross-chain transfer of a full-chain asset, to facilitate external auditing and verification. Token airdrop may refer to issuing (that is, giving) a particular amount of digital assets to a particular object for free.

A multi-blockchain network may include multiple blockchains, and the foregoing information may be deployed on each blockchain. A target full-chain service contract on each blockchain may be bound to a contract address corresponding to a target full-chain service contract on a remaining blockchain. In this case, a digital asset on a blockchain may circulate on each blockchain in the multi-blockchain network. For example, the multi-blockchain network includes a first blockchain, a second blockchain, and a third blockchain. A target full-chain service contract 1 is deployed on the first blockchain, a target full-chain service contract 2 is deployed on the second blockchain, and a target full-chain service contract 3 is deployed on the third blockchain. A contract address corresponding to the target full-chain service contract 2 and a contract address corresponding to the target full-chain service contract 3 may be bound to the target full-chain service contract 1 deployed on the first blockchain. In this case, remote contract addresses bound to the target full-chain service contract 1 include the contract address corresponding to the target full-chain service contract 2 and the contract address corresponding to the target full-chain service contract 3, and the target full-chain service contract 2 and the target full-chain service contract 3 are used as remote full-chain service contracts of the target full-chain service contract 1. When a digital asset needs to be transferred from the first blockchain to the second blockchain, the target full-chain service contract 2 is used as a target remote full-chain service contract corresponding to the target full-chain service contract 1, and the contract address corresponding to the target full-chain service contract 2 is a target remote contract address corresponding to the target full-chain service contract 1. Accordingly, a contract address corresponding to the target full-chain service contract 1 and the contract address corresponding to the target full-chain service contract 3 may be bound to the target full-chain service contract 2 deployed on the second blockchain. In this case, remote contract addresses bound to the target full-chain service contract 2 include the contract address corresponding to the target full-chain service contract 1 and the contract address corresponding to the target full-chain service contract 3, and the target full-chain service contract 1 and the target full-chain service contract 3 are used as remote full-chain service contracts of the target full-chain service contract 2. Similarly, the contract address corresponding to the target full-chain service contract 1 and the contract address corresponding to the target full-chain service contract 2 may be bound to the target full-chain service contract 3 deployed on the third blockchain. In this case, remote contract addresses bound to the target full-chain service contract 3 include the contract address corresponding to the target full-chain service contract 1 and the contract address corresponding to the target full-chain service contract 2, and the target full-chain service contract 1 and the target full-chain service contract 2 are used as remote full-chain service contracts of the target full-chain service contract 3.

As shown in FIG. 2, data interaction is performed between any two blockchains (for example, the first blockchain and the second blockchain) in the multi-blockchain network by using an off-chain cross-chain service device (also referred to as a cross-chain relay), and an off-chain full-chain cross-chain service 219 may be deployed on the off-chain cross-chain service device. The off-chain full-chain cross-chain service may include a unified full-chain registration service 220, an information management and verification service 221, and a cross-chain event verification and forwarding service 222. The unified full-chain registration service may be configured to interact with a full-chain identifier allocation protocol in a full-chain service contract, to implement an initialization operation such as an operation of allocating a related blockchain identifier in the full-chain identifier allocation protocol, and may maintain management of multiple blockchains (for example, addition, deletion, change, and check of any one of the multiple blockchains). The information management and verification service may be configured to interact with the key information disclosing interface in the full-chain service parent contract, to continuously perform security verification on the node port information disclosed by the key information disclosing interface, to ensure correctness and consistency of the node port information. The cross-chain event verification and forwarding service may be configured to forward an event between any two blockchains (for example, the first blockchain and the second blockchain) in the multi-blockchain network (for example, when a cross-chain asset transfer event is detected on a first blockchain node of the first blockchain, a cross-chain asset reconstruction transaction corresponding to the cross-chain asset transfer event is constructed and forwarded to a second blockchain node of the second blockchain).

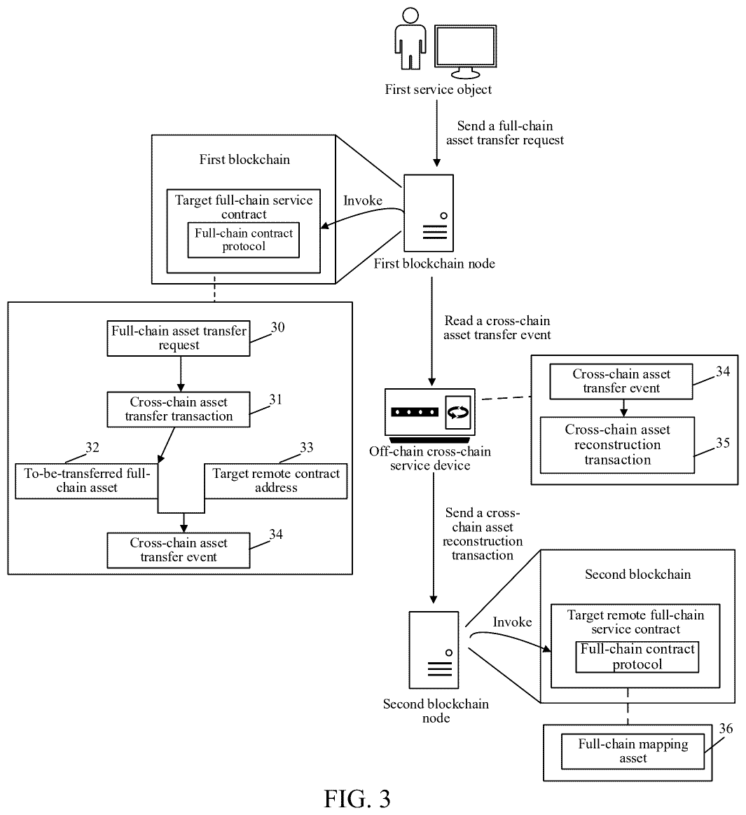

For ease of understanding, further, FIG. 3 is a schematic diagram of a data processing scenario based on multiple blockchains according to an embodiment of this disclosure. In this scenario, a cross-chain transfer mechanism for a digital asset is provided. A to-be-transferred full-chain asset may be transferred from a first blockchain to a second blockchain by using the cross-chain transfer mechanism for a digital asset. In this embodiment of this disclosure, a first blockchain network configured to maintain the first blockchain may be the first blockchain network 200 in FIG. 1, and a first blockchain node in the first blockchain network may be any blockchain node in the first blockchain network 200 in FIG. 1 (for example, the blockchain node 20a in the first blockchain network 200). In addition, a second blockchain network configured to maintain the second blockchain may be the second blockchain network 300 in FIG. 1, and a second blockchain node in the second blockchain network may be any blockchain node in the second blockchain network 300 in FIG. 1 (for example, the blockchain node 30a in the second blockchain network 300). A cross-chain transfer process for a full-chain asset may be: The first blockchain node obtains a full-chain asset transfer request 30 sent by a first service object for a service transaction, invokes a target full-chain service contract on the first blockchain when it is determined, based on the full-chain asset transfer request, that the service transaction is a cross-chain asset transfer transaction 31, and uses a full-chain asset associated with the cross-chain asset transfer transaction as a to-be-transferred full-chain asset 32, the cross-chain asset transfer transaction being used to instruct to transfer the to-be-transferred full-chain asset from the first blockchain to the second blockchain. The first blockchain node may invoke a full-chain contract protocol integrated in the target full-chain service contract, determine, based on the cross-chain asset transfer transaction, a target remote contract address 33 bound to the target full-chain service contract (for example, a contract address corresponding to the target full-chain service contract deployed on the second blockchain), and generate, based on the target remote contract address and the to-be-transferred full-chain asset, a cross-chain asset transfer event 34 corresponding to the cross-chain asset transfer transaction. When reading the cross-chain asset transfer event from the first blockchain node, the off-chain cross-chain service device constructs a cross-chain asset reconstruction transaction 35 corresponding to the cross-chain asset transfer event, and sends the cross-chain asset reconstruction transaction corresponding to the cross-chain asset transfer event to the second blockchain node in the second blockchain network. The second blockchain node may determine, on the second blockchain based on the cross-chain asset reconstruction transaction, a target remote full-chain service contract (the target remote full-chain service contract is integrated with the full-chain contract protocol) corresponding to the target remote contract address, and invoke the target remote full-chain service contract to generate a full-chain mapping asset 36 that corresponds to the to-be-transferred full-chain asset and that is on the second blockchain, where asset content and asset data information of the full-chain mapping asset are the same as asset content and asset data information of the to-be-transferred full-chain asset.

The first blockchain and the second blockchain may implement cross-chain transfer of a full-chain asset based on a unified asset transfer rule specified in the full-chain contract protocol in the target full-chain service contract. At the same time, the asset content and the asset data information of the full-chain mapping asset may be the same as the asset content and the asset data information of the to-be-transferred full-chain asset. Therefore, the full-chain mapping asset generated on the second blockchain and the to-be-transferred full-chain asset on the first blockchain may be considered as the same asset, thereby implementing full-chain circulation of the full-chain asset in multiple blockchains, to improve mobility of the full-chain asset. The full-chain asset may be any type of on-chain asset, such as a digital collection and a game point in a game scenario. If the technical solution of this disclosure is applied to a game scenario, the full-chain asset may be a to-be-exchanged game point. For example, a game point of a game player may circulate on the first blockchain, and a game point exchange service (for example, the game point is exchanged for role equipment) may be deployed on the second blockchain. Therefore, when the game player needs to perform a game point exchange service, a game point that needs to be transferred may be transferred to the second blockchain by using the foregoing technical solution, so that the game player may perform a related exchange service on the transferred game point (that is, a mapped game point) on the second blockchain.

The first blockchain node and the second blockchain node involved in the embodiments of this disclosure may be the foregoing computer device. The computer device may be an independent physical server, or may be a server cluster including multiple physical servers or a distributed system, or may be a cloud server providing basic cloud computing services, such as a cloud service, a cloud database, cloud computing, a cloud function, cloud storage, a network service, cloud communication, a middleware service, a domain name service, a security service, a CDN, big data, and an artificial intelligence platform.

The first blockchain node and the second blockchain node in the embodiments of this disclosure can display a prompt interface or a pop-up window when obtaining object data (for example, object information or a full-chain asset of a service object) of a service object (for example, the foregoing individual object or enterprise object) across chains. The prompt interface or the pop-up window is used to indicate to the service object that object data is to be collected. Only after obtaining a confirmation operation of the service object on the prompt interface or the pop-up window, related operations of obtaining data may be executed. Otherwise, the process ends.

In addition, in a specific implementation of this disclosure, object data of a service object (for example, object information or a full-chain asset of a service object) may be involved. When the foregoing embodiments of this disclosure are applied to a specific product or technology, permission or consent of a service object is required, and collection, use, and processing of the related data need to comply with relevant laws, regulations, and standards of relevant regions.

For a specific process of implementing cross-chain circulation of a full-chain asset in a multi-blockchain network, refer to the embodiments described below.

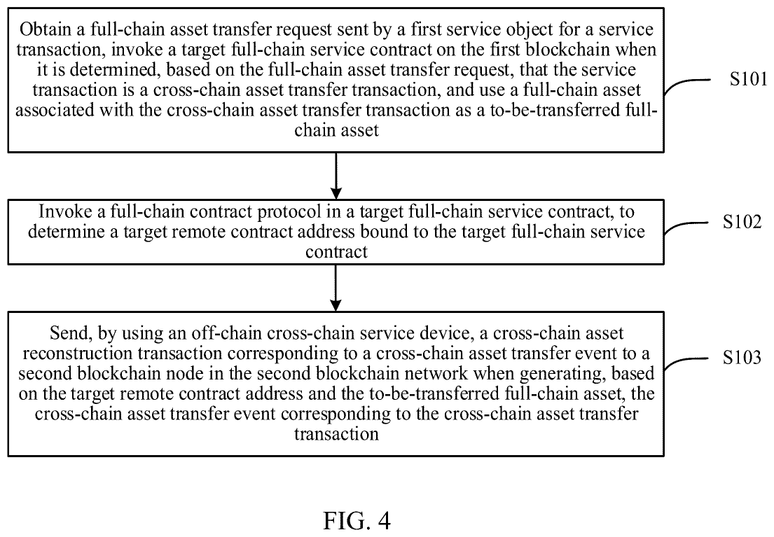

Further, FIG. 4 is a schematic flowchart of a data processing method based on multiple blockchains according to an embodiment of this disclosure. The multiple blockchains at least include a first blockchain and a second blockchain, the first blockchain corresponds to a first blockchain network, the second blockchain corresponds to a second blockchain network, and the first blockchain network is independent of the second blockchain network. A blockchain network corresponding to the first blockchain is referred to as the first blockchain network, and the first blockchain corresponds to the first blockchain network. This indicates that the first blockchain is maintained by the first blockchain network. A blockchain network corresponding to the second blockchain is referred to as the second blockchain network, and the second blockchain corresponds to the second blockchain network. This indicates that the second blockchain is maintained by the second blockchain network.

As shown in FIG. 4, the method may be performed by a first blockchain node in the first blockchain network, and may be specifically performed by a computer device maintaining the first blockchain node. The first blockchain node is a blockchain node in the first blockchain, to be distinguished from a blockchain node in the second blockchain. For example, the first blockchain node may be any blockchain node in a first blockchain network 200 shown in FIG. 1. The method may specifically include the following operation S101 to operation S103.

S101: Obtain a full-chain asset transfer request sent by a first service object for a service transaction, invoke a target full-chain service contract on the first blockchain when it is determined, based on the full-chain asset transfer request, that the service transaction is a cross-chain asset transfer transaction, and use a full-chain asset associated with the cross-chain asset transfer transaction as a to-be-transferred full-chain asset.

The cross-chain asset transfer transaction is used to instruct to transfer the to-be-transferred full-chain asset from the first blockchain to the second blockchain. The first service object is an object to which the to-be-transferred full-chain asset belongs. The object may be a user or a computer device. The full-chain asset transfer request may be a request for transferring a full-chain asset based on at least one blockchain of multiple blockchains. The full-chain asset may be a unique digital asset in multiple blockchains.

The first service object may initiate a cross-chain asset transfer transaction for the to-be-transferred full-chain asset, and a terminal of the first service object generates a full-chain asset transfer request based on the cross-chain asset transfer transaction, and sends the full-chain asset transfer request to the first blockchain node in the first blockchain network. When determining that a service transaction indicated by the full-chain asset transfer request is a cross-chain asset transfer transaction for a full-chain asset, the first blockchain node executes the cross-chain asset transfer transaction, to transfer the to-be-transferred full-chain asset from the first blockchain to the second blockchain. For example, when the first service object needs to transfer a specified digital asset (for example, one or more digital collections) from the first blockchain to the second blockchain, the first service object may generate a cross-chain asset transfer transaction for the specified digital asset, and then generate a cross-chain asset transfer request corresponding to the cross-chain asset transfer transaction, so as to transfer the specified digital asset (that is, a to-be-transferred full-chain asset) from the first blockchain to the second blockchain. The full-chain asset associated with the cross-chain asset transfer transaction is a to-be-transferred asset indicated by the cross-chain asset transfer transaction.

The to-be-transferred full-chain asset may be a native asset determined on the first blockchain, or may be a mapping asset that is generated on the first blockchain by the first blockchain node and that is transferred from another service chain to the first blockchain. When the to-be-transferred full-chain asset is a native asset determined on the first blockchain, an asset identifier of the to-be-transferred full-chain asset is generated by the first blockchain node. When the to-be-transferred full-chain asset is an asset transferred from another service chain to the first blockchain, the asset identifier of the to-be-transferred full-chain asset is generated by a blockchain node associated with the another service chain. That is, the asset identifier of the to-be-transferred full-chain asset is generated by a blockchain node associated with a service chain in which the to-be-transferred full-chain asset is a native full-chain asset. For example, the asset identifier of the to-be-transferred full-chain asset is generated by the first blockchain node. The to-be-transferred full-chain asset may belong to some or all of full-chain assets for cross-chain transfer that are determined on the first blockchain. The full-chain asset for cross-chain transfer that is determined on the first blockchain is a full-chain asset whose asset identifier is generated by the first blockchain node and that is used for cross-chain transfer.

Therefore, a process of determining the full-chain asset for cross-chain transfer on the first blockchain may be: obtaining a full-chain asset determining request for a full-chain asset determining transaction, invoking the target full-chain service contract on the first blockchain based on the full-chain asset determining request, and determining a determined asset quantity of the full-chain asset determining transaction as a to-be-determined asset quantity; invoking the full-chain contract protocol in the target full-chain service contract, to obtain an identifier prefix associated with the first blockchain, and generating, based on the identifier prefix associated with the first blockchain and an asset identifier template configured in the full-chain contract protocol, a to-be-determined full-chain asset identifier corresponding to the to-be-determined asset quantity, where the to-be-determined full-chain asset identifier includes the identifier prefix associated with the first blockchain; and invoking an asset determining contract in the target full-chain service contract, to determine, on the first blockchain, a full-chain asset corresponding to the to-be-determined full-chain asset identifier, and using the determined full-chain asset as a full-chain asset for cross-chain transfer determined on the first blockchain.

The full-chain asset determining transaction may be used to indicate a quantity of full-chain assets (for example, 100 digital collections) that need to be determined on the first blockchain. The first blockchain node needs to allocate an asset identifier to each to-be-determined full-chain asset (for example, allocate an asset identifier to each of the 100 digital collections). The asset identifier is used to uniquely identify a corresponding full-chain asset. The asset identifier may be used to determine a service chain to which the full-chain asset originally belongs, and a service chain whose associated blockchain node determines the asset. In this way, a service chain to which a full-chain asset originally belongs can still be known when the full-chain asset circulates on multiple blockchains.

The identifier prefix associated with the first blockchain may be a blockchain identifier of the first blockchain, or may be identifier information generated based on a blockchain identifier of the first blockchain. For example, a hash value obtained by performing hash calculation on the blockchain identifier of the first blockchain is used as the identifier prefix associated with the first blockchain. This is not limited herein. The asset identifier template is used to define an identifier form of a generated asset identifier, such as a length of the asset identifier and whether the asset identifier includes an uppercase letter and a lowercase letter. This is not limited herein. In this way, a full-chain asset determined on a service chain (the full-chain asset herein is not a full-chain mapping asset generated in a cross-chain transfer scenario, and instead is a native full-chain asset generated by using a full-chain asset determining transaction submitted by a related service object) has a unique full-chain asset identifier. That is, asset identifiers of native full-chain assets determined by using target full-chain service contracts on any two service chains cannot be the same. In this way, a full-chain asset may maintain uniqueness in full-chain circulation on multiple blockchains, and a full-chain asset does not conflict with an existing asset on another service chain when flowing from one service chain to the another service chain. In addition, a service chain whose associated blockchain node initially determines the full-chain asset may be known. The identifier prefix of the asset identifier depends on an identifier prefix provided by a service chain in which the asset identifier is located. The asset identifier template may be specified in a full-chain service parent contract, and may be obtained by using a full-chain contract protocol in the target full-chain service contract.

S102: Invoke a full-chain contract protocol in a target full-chain service contract, to determine a target remote contract address bound to the target full-chain service contract.

The full-chain contract protocol is determined based on a full-chain contract protocol interface provided by a full-chain service parent contract on the first blockchain, and a target remote full-chain service contract corresponding to the target remote contract address is a full-chain service contract that is on the second blockchain and integrated with the full-chain contract protocol. The full-chain service parent contract and the target full-chain service contract may be deployed on each of the multiple blockchains. The target full-chain service contract on each blockchain is integrated with a full-chain contract protocol indicated by a full-chain contract protocol interface provided by the full-chain service parent contract. A processing rule related to the full-chain asset (for example, a full-chain asset transfer rule and a full-chain asset determining rule) is defined in the full-chain contract protocol. In this way, each of the multiple blockchains may implement asset transfer by using a unified rule, thereby implementing full-chain asset circulation.

The target full-chain service contract on the first blockchain is bound to a contract address of a target full-chain service contract on another service chain of the multiple blockchains. That is, a remote contract address bound to the target full-chain service contract on the first blockchain includes a contract address of a target full-chain service contract on the another service chain. In this case, the target full-chain service contract on the another service chain is a remote full-chain service contract corresponding to the target full-chain service contract on the first blockchain. The target full-chain service contract on the blockchain (the second blockchain) to which the asset is to be transferred indicated by the cross-chain asset transfer transaction is the target remote full-chain service contract herein, and the contract address of the target full-chain service contract on the blockchain (the second blockchain) to which the asset is to be transferred is the target remote contract address herein. Besides, only when a target full-chain service contract on one blockchain is bound to a contract address of a target full-chain service contract on another blockchain, a full-chain asset on the blockchain can be transferred to the another blockchain.

The cross-chain asset transfer transaction is used to instruct to transfer the to-be-transferred full-chain asset from the first blockchain to the second blockchain, that is, the cross-chain asset transfer transaction carries the second blockchain identifier of the second blockchain. Therefore, the invoking a full-chain contract protocol in a target full-chain service contract, to determine a target remote contract address bound to the target full-chain service contract may be: invoking a full-chain contract protocol in the target full-chain service contract, to obtain a remote contract address bound to the target full-chain service contract; where the remote contract address bound to the target full-chain service contract includes a contract address corresponding to a full-chain service contract that is on a reference service chain and integrated with the full-chain contract protocol; the reference service chain is a blockchain (that is, the another service chain) of the multiple blockchains other than the first blockchain; and the reference service chain includes the second blockchain. A remote contract address associated with the second blockchain identifier is determined as the target remote contract address in the remote contract address bound to the target full-chain service contract.

S103: Transmit, by using an off-chain cross-chain service device, a cross-chain asset reconstruction transaction corresponding to a cross-chain asset transfer event to a second blockchain node in the second blockchain network when generating, based on the target remote contract address and the to-be-transferred full-chain asset, the cross-chain asset transfer event corresponding to the cross-chain asset transfer transaction.

The first blockchain node may generate, based on the target remote contract address and the to-be-transferred full-chain asset, the cross-chain asset transfer event corresponding to the cross-chain asset transfer transaction. The cross-chain asset transfer event may be used to instruct cross-chain transfer of the to-be-transferred full-chain asset from the target full-chain service contract on the first blockchain to the target full-chain service contract indicated by the target remote contract address on the second blockchain.

When the to-be-transferred full-chain asset is transferred from the first blockchain to the second blockchain, the to-be-transferred full-chain asset on the first blockchain is actually locked and the full-chain mapping asset corresponding to the to-be-transferred full-chain asset is determined on the second blockchain. Therefore, the generating the cross-chain asset transfer event corresponding to the cross-chain asset transfer transaction may be: invoking the target full-chain service contract to switch an asset status of the to-be-transferred full-chain asset from a first status to a second status, where the second status is an asset locked status, and the first status is an asset unlocked status; and when the asset status of the to-be-transferred full-chain asset is the second status, generating, based on the target remote contract address and the to-be-transferred full-chain asset, the cross-chain asset transfer event corresponding to the cross-chain asset transfer transaction. That is, the to-be-transferred full-chain asset may be locked by using the target full-chain service contract, and the cross-chain asset transfer event is generated when the to-be-transferred full-chain asset on the first blockchain is locked. In this case, although the to-be-transferred full-chain asset is actually on the first blockchain, no service operation can be performed on the to-be-transferred full-chain asset on the first blockchain.

In addition, when the cross-chain asset transfer event is generated on the first blockchain, a unique full-chain event identifier (event nonce) on multiple blockchains may also be generated for the cross-chain asset transfer event, to facilitate event query. Therefore, the generating a cross-chain asset transfer event corresponding to the cross-chain asset transfer transaction may be: obtaining the first blockchain identifier of the first blockchain, for example, the first blockchain identifier is obtained by using a full-chain identifier allocation protocol in a full-chain service contract, and the first blockchain identifier is a blockchain identifier configured for the first blockchain through a unified full-chain registration service in an off-chain full-chain cross-chain service, invoking a full-chain event identifier generation protocol in the full-chain service contract based on the first blockchain identifier, to generate an event identifier associated with the first blockchain identifier; and generating, based on the event identifier, the target remote contract address, and the to-be-transferred full-chain asset, the cross-chain asset transfer event corresponding to the cross-chain asset transfer transaction. The cross-chain asset transfer event carries the generated event identifier. Because blockchain identifiers configured for the multiple blockchains are different, when generating the event identifier, the event identifier may be generated in an associated manner based on a blockchain identifier of a service chain on which the event identifier is located. In this way, the generated event identifier may be used to indicate that the event identifier is generated on the service chain on which the event identifier is located. Therefore, when the event is forwarded, event query on multiple blockchains may be implemented. For example, a related service object or third party may easily match a service transaction on the source chain (for example, the first blockchain) and the target chain (for example, the second blockchain) based on the event identifier, to manage and maintain a life cycle of an entire status of a related service or a full-chain asset on the full-chain.

The off-chain cross-chain service device is a device not belonging to the first blockchain network and the second blockchain network. The off-chain cross-chain service device is configured to forward an event between the first blockchain and the second blockchain. An off-chain full-chain cross-chain service is deployed on the off-chain cross-chain service device. The off-chain full-chain cross-chain service includes a cross-chain event verification and forwarding service. The cross-chain event verification and forwarding service may be configured to implement event verification and forwarding on a cross-chain asset transfer event when the off-chain cross-chain service device reads the cross-chain asset transfer event from the first blockchain node. An event verification process may include an asset verification process and a transaction verification process.

The cross-chain asset transfer event carries an asset identifier of the to-be-transferred full-chain asset, and the asset identifier of the to-be-transferred full-chain asset is generated based on an identifier prefix associated with the first blockchain and an asset identifier template configured in the full-chain contract protocol. The cross-chain asset reconstruction transaction corresponding to the cross-chain asset transfer event is constructed when the off-chain cross-chain service device performs, based on the identifier prefix and the asset identifier template, identifier verification on the asset identifier of the to-be-transferred full-chain asset carried in the cross-chain asset transfer event and succeeds in the identifier verification.

The asset verification process may refer to performing, based on the identifier prefix and the asset identifier template, identifier verification on the asset identifier of the to-be-transferred full-chain asset carried in the cross-chain asset transfer event. That is, it may be verified whether the identifier prefix in the asset identifier of the to-be-transferred full-chain asset is the same as the identifier prefix associated with the first blockchain, and whether the asset identifier of the to-be-transferred full-chain asset matches the asset identifier template, to implement identifier verification on the asset identifier of the to-be-transferred full-chain asset. When the off-chain cross-chain service device determines that the identifier prefix in the asset identifier of the to-be-transferred full-chain asset is the same as the identifier prefix associated with the first blockchain, and the asset identifier of the to-be-transferred full-chain asset matches the asset identifier template, it is determined that the identifier verification succeeds.

In addition, the off-chain cross-chain service device may be configured to isolate the first blockchain network from the second blockchain network. The generating, by the first blockchain node, the cross-chain asset transfer event may be: performing transaction signature on the cross-chain asset transfer transaction by using private key information negotiated with the off-chain cross-chain service device, using the cross-chain asset transfer transaction on which the transaction signature is performed as event signature information, and generating the cross-chain asset transfer event based on the event signature information and the cross-chain asset transfer transaction. The cross-chain asset transfer event read by the off-chain cross-chain service device from the first blockchain node may include the event signature information and the cross-chain asset transfer transaction. Therefore, the transaction verification process may be: performing signature verification on the event signature information in the cross-chain asset transfer event by using public key information corresponding to private key information of the first blockchain, after the signature verification succeeds, obtaining a to-be-verified transaction parameter corresponding to the event signature information, and performing transaction comparison on the cross-chain asset transfer transaction carried in the cross-chain asset transfer event and the to-be-verified transaction parameter, to obtain a transaction comparison result to determine a transaction verification result. If the cross-chain asset transfer transaction carried in the cross-chain asset transfer event is the same as the to-be-verified transaction parameter, the transaction comparison result indicates that transaction verification succeeds. If the cross-chain asset transfer transaction carried in the cross-chain asset transfer event is not the same as the to-be-verified transaction parameter, the transaction comparison result indicates that transaction verification fails. Only when determining that the identifier verification succeeds and the transaction verification succeeds, the off-chain cross-chain service device constructs the cross-chain asset reconstruction transaction corresponding to the cross-chain asset transfer event. The cross-chain asset reconstruction transaction is used to instruct to transfer the to-be-transferred full-chain asset from the first blockchain to the second blockchain.

In addition, the off-chain cross-chain service device may perform verification on and forward, each time the off-chain cross-chain service device reads a cross-chain asset transfer event, the cross-chain asset transfer event by using the cross-chain event verification and forwarding service. Alternatively, the off-chain cross-chain service device may perform verification on and forward, by using the cross-chain event verification and forwarding service when the off-chain cross-chain service device reads a target cross-chain asset transfer event occurring in a target cycle, the target cross-chain asset transfer event occurring in the target cycle. That is, the cross-chain asset transfer event that is associated with the target full-chain service contract and that is generated in the target cycle may be read by using the off-chain cross-chain service device. When reading a cross-chain asset transfer event associated with the target full-chain service contract, the off-chain cross-chain service device is configured to perform event verification on the cross-chain asset transfer event by using the cross-chain event verification and forwarding service in the off-chain full-chain cross-chain service, and for the cross-chain asset transfer event for which the event verification succeeds, forward a cross-chain asset reconstruction transaction corresponding to the cross-chain asset transfer event. That is, the off-chain cross-chain service device generates a cross-chain asset reconstruction transaction corresponding to the cross-chain asset transfer event, and sends the cross-chain asset reconstruction transaction to the second blockchain node. One cycle may be one hour, two hours, or the like, and duration of the cycle is not limited herein.

After the first service object transfers the to-be-transferred full-chain asset from the first blockchain to the second blockchain, if the to-be-transferred full-chain asset (that is, a full-chain mapping asset) needs to be used on the second blockchain, additional native fuel (which may also be referred to as a basic token) also needs to be transferred to the second blockchain. In this case, a full-chain token airdrop contract on the first blockchain may be used to implement that when generating the cross-chain asset transfer event corresponding to the cross-chain asset transfer transaction, a to-be-airdropped full-chain token is carried in the cross-chain asset transfer event.

Therefore, before generating the cross-chain asset transfer event corresponding to the cross-chain asset transfer transaction, the first blockchain node may invoke the full-chain token airdrop contract on the first blockchain by using the target full-chain service contract, to obtain the first blockchain token (that is, a source chain token) associated with the to-be-transferred full-chain asset, and use the obtained first blockchain token as the to-be-airdropped full-chain token. In this way, when generating the cross-chain asset transfer event corresponding to the cross-chain asset transfer transaction, the first blockchain node writes the to-be-airdropped full-chain token into the cross-chain asset transfer event. By using the full-chain token airdrop contract, the first blockchain node does not need an additional operation to implement transfer of a basic token, and instead uses the to-be-airdropped full-chain token as an airdrop fee and directly completes at the same time as a process of cross-chain transfer of the full-chain asset, thereby implementing a cross-chain operation on a source chain (the first blockchain) side in cross-chain transfer of the full-chain asset.

The off-chain cross-chain service device may send, to the second blockchain node in the second blockchain network, the cross-chain asset reconstruction transaction generated based on the cross-chain asset transfer event, so that the second blockchain node determines, on the second blockchain based on the cross-chain asset reconstruction transaction, the target remote full-chain service contract corresponding to the target remote contract address, and invokes the target remote full-chain service contract to generate, on the second blockchain, a full-chain mapping asset corresponding to the to-be-transferred full-chain asset, asset data information of the full-chain mapping asset being the same as asset data information of the to-be-transferred full-chain resource. In addition, the second blockchain node may determine, by using the full-chain token airdrop contract, a second blockchain airdrop token corresponding to the to-be-airdropped full-chain token carried in the cross-chain asset reconstruction transaction, and use the second blockchain airdrop token as a full-chain token of the full-chain mapping asset on the second blockchain. For related operations of the second blockchain node, refer to related descriptions in the following embodiments.

An asset circulating on the first blockchain may be transferred to the second blockchain (that is, inter-chain transfer), and may be transferred within the first blockchain (that is, intra-chain transfer, for example, a service transaction such as money transfer). That is, the first blockchain includes an asset that needs to circulate across chains and an asset that circulates within the chain. The asset transferred from the first blockchain to the second blockchain may circulate on the second blockchain. That is, the asset circulating on the second blockchain may include a native asset determined on the second blockchain and may also include the asset transferred from the first blockchain (the asset is essentially also determined on the second blockchain, but the determined asset is a full-chain mapping asset, the asset data information is asset data information related to the first blockchain, and asset data information of the native asset determined on the second blockchain is asset data information related to the second blockchain). As required in a particular service scenario, the asset on the second blockchain may also be transferred to the first blockchain, to circulate on the first blockchain. A process and a principle of cross-chain transfer of the asset on the second blockchain are the same as those of cross-chain transfer of the asset on the first blockchain. Refer to the related descriptions of cross-chain transfer of the full-chain asset on the first blockchain, and details are not described herein again.

For example, the asset on the first blockchain includes a to-be-transferred full-chain asset for cross-chain transfer (P11) and an asset circulating on the first blockchain (P12). Herein, P12 is used as a native asset determined on the first blockchain. Asset data information of P12 is associated with the first blockchain, and correspondingly, asset data information of P11 is associated with the first blockchain. The asset on the second blockchain includes a full-chain mapping asset (P11′) that is determined for P11 and that is used to circulate on the second blockchain, and includes an asset circulating on the second blockchain (P21). Herein, P21 is a native asset determined on the second blockchain. Asset data information of P21 is associated with the second blockchain, and asset data information of P11′ is the same as that of P11. That is, the asset data information of P11′ is associated with the first blockchain, and P11′ and P11 may be considered as the same asset having the same asset content and the same asset data information. The asset on the second blockchain may further include a to-be-transferred full-chain asset for cross-chain transfer (P22). Asset data information of P22 is associated with the second blockchain. In this case, the asset on the first blockchain may further include a full-chain mapping asset (P22′) that is determined for P22 and that is used to circulate on the first blockchain. In this case, asset data information of P22′ is the same as that of P22. That is, the asset data information of P22′ is associated with the second blockchain, and P22′ and P22 may be considered as the same asset having the same asset content and the same asset data information.

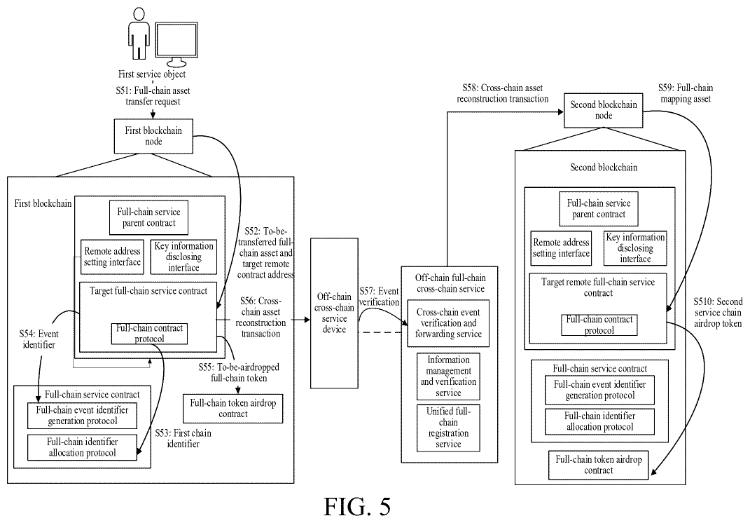

For example, FIG. 5 is a schematic diagram of a cross-chain asset transfer scenario according to an embodiment of this disclosure. S51: A first service object sends a full-chain asset transfer request for a cross-chain asset transfer transaction by using a client. S52: A first blockchain node (for example, the first blockchain node shown in FIG. 2) invokes a target full-chain service contract on a first blockchain to use a full-chain asset associated with the cross-chain asset transfer transaction as a to-be-transferred full-chain asset, and invokes a full-chain contract protocol in the target full-chain service contract, to determine a target remote contract address bound to the target full-chain service contract. S53: The first blockchain node invokes, by using the target full-chain service contract, a full-chain identifier allocation protocol in the full-chain service contract to obtain a first blockchain identifier of the first blockchain. S54: The first blockchain node invokes a full-chain event identifier generation protocol in the full-chain service contract based on the first blockchain identifier, to generate an event identifier associated with the first blockchain identifier. S55: The first blockchain node invokes a full-chain token airdrop contract on the first blockchain by using the target full-chain service contract, to obtain a first blockchain token associated with the to-be-transferred full-chain asset, and uses the obtained first blockchain token as a to-be-airdropped full-chain token. S56: The first blockchain node generates a cross-chain asset transfer event based on the event identifier, the target remote contract address, the to-be-transferred full-chain asset, and the to-be-airdropped full-chain token. S57: When reading the cross-chain asset transfer event from the first blockchain node, an off-chain cross-chain service device (the off-chain cross-chain service device shown in FIG. 2) performs event verification on the cross-chain asset transfer event by using a cross-chain event verification and forwarding service in a deployed off-chain full-chain cross-chain service, and after the event verification succeeds, generates a cross-chain asset reconstruction transaction corresponding to the cross-chain asset transfer event. S58: The off-chain cross-chain service device forwards the cross-chain asset reconstruction transaction to a second blockchain node, to implement forwarding of the cross-chain asset transfer event. The off-chain cross-chain service device may send the cross-chain asset reconstruction transaction to the second blockchain node (the second blockchain node shown in FIG. 2) in a second blockchain network. S59: The second blockchain node determines, on the second blockchain based on the cross-chain asset reconstruction transaction, the target remote full-chain service contract corresponding to the target remote contract address, and invokes the target remote full-chain service contract to generate, on the second blockchain, a full-chain mapping asset corresponding to the to-be-transferred full-chain asset. S510: The second blockchain node invokes, by using a target remote full-chain service contract, a full-chain token airdrop contract to determine a second blockchain airdrop token corresponding to a to-be-airdropped full-chain token carried in the cross-chain asset reconstruction transaction.

Because the asset data information (for example, information such as an asset identifier) of the full-chain mapping asset is the same as the asset data information of the to-be-transferred full-chain resource, the full-chain mapping asset and the to-be-transferred full-chain asset may be considered as the same asset. Therefore, it may be considered as the to-be-transferred full-chain asset circulating to the second blockchain, thereby implementing full-chain circulation of the digital asset. A full-chain asset may circulate to any one of the multiple blockchains. For example, the to-be-transferred full-chain asset circulates from the first blockchain to the second blockchain, and then circulates from the second blockchain to a third service chain of the multiple blockchains. In this case, the to-be-transferred full-chain asset circulating to the third service chain may still be understood as a native asset on the first blockchain.

In this embodiment of this disclosure, the multiple blockchains may include a first blockchain and a second blockchain. A cross-chain asset transfer transaction corresponding to a full-chain asset transfer request is used to instruct to transfer a to-be-transferred full-chain asset (which is, for example, a digital asset and may be specifically a digital collection) from the first blockchain to the second blockchain. In this solution, a full-chain service contract integrated with the same full-chain contract protocol may be deployed on the first blockchain and the second blockchain to implement cross-chain transfer of the to-be-transferred full-chain asset. The target full-chain service contract for executing the cross-chain asset transfer transaction is deployed on the first blockchain, and a full-chain service contract that corresponds to the target full-chain service contract and that is on the second blockchain is a target remote full-chain service contract. The target full-chain service contract and the target remote full-chain service contract are integrated with the same full-chain contract protocol, that is, the target full-chain service contract and the target remote full-chain service contract are integrated with the same asset transfer method (for example, an asset transfer related method or an asset determining related method), that is, an asset determining rule on the first blockchain is the same as an asset determining rule on the second blockchain. Therefore, the first blockchain node may invoke the full-chain contract protocol in the target full-chain service contract to generate a cross-chain asset transfer event corresponding to the cross-chain asset transfer transaction, to implement cross-chain transfer of the to-be-transferred full-chain asset. The second blockchain node may invoke the full-chain contract protocol in the target remote full-chain service contract based on the cross-chain asset reconstruction transaction corresponding to the cross-chain asset transfer event, to determine the to-be-transferred full-chain asset. Because the first blockchain node and the second blockchain node transfer and determine the digital asset by using an asset transfer method uniformly specified in the same full-chain contract protocol, asset data information of the full-chain mapping asset determined by the second blockchain node may be the same as asset data information of the to-be-transferred full-chain asset. In this case, the to-be-transferred full-chain asset on the first blockchain and the mapping asset on the second blockchain may be considered as the same asset. In this way, full-chain circulation of the same digital asset may be securely implemented between different blockchains, thereby improving mobility of digital asset between multiple blockchains.

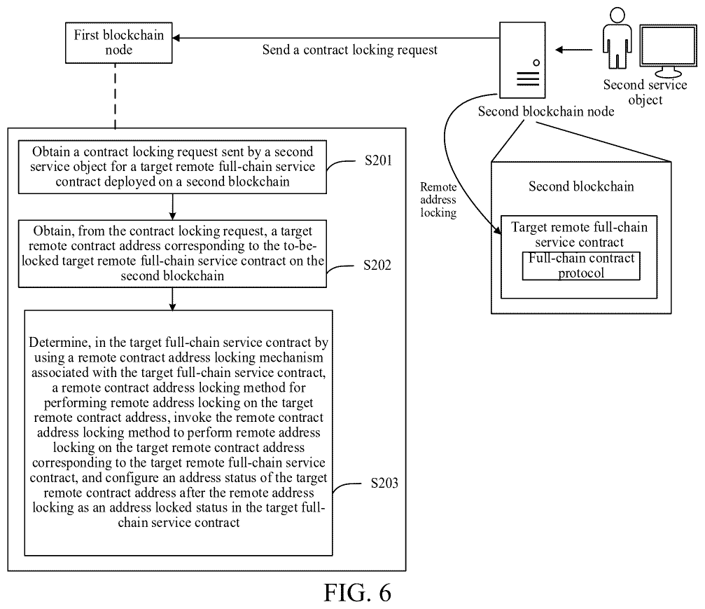

Further, FIG. 6 is a schematic flowchart of a data processing method based on multiple blockchains according to an embodiment of this disclosure. As shown in FIG. 6, the method may be performed by the first blockchain node in the first blockchain network. For example, the first blockchain node may be any blockchain node in the first blockchain network 200 shown in FIG. 1. The method may specifically include the following operation S201 to operation S203.

S201: Obtain a contract locking request sent by a second service object for a target remote full-chain service contract deployed on a second blockchain.

In a scenario, there is a contract update (or upgrade) case. In this case, to ensure that a full-chain asset is not lost, the target full-chain service contract may be locked by using a remote contract address locking mechanism, to suspend cross-chain transfer of the full-chain asset. The remote contract address locking mechanism is used for locking, in a target full-chain service contract on a service chain, a specified remote contract address on another service chain. Contract update processes on service chains are the same. An example of contract update on the second blockchain is used herein to describe an execution process of the scenario, and an example in which the multiple blockchains include the first blockchain and the second blockchain is used. That is, when the contract status of the target remote full-chain service contract on the second blockchain is the contract update status, operations S201 to operation S203 in this embodiment of this disclosure may be performed.

The second service object is a service object that is on the second blockchain and that corresponds to the target remote full-chain service contract. The contract locking request is generated after the second service object performs, in the target remote full-chain service contract deployed on the second blockchain, remote address locking on a contract address corresponding to the target full-chain service contract. The second service object may be a contract owner that is on the second blockchain and that corresponds to the target remote full-chain service contract. When the second service object updates the target remote full-chain service contract on the second blockchain, remote address locking is first performed in the target remote full-chain service contract on the second blockchain, and after remote address locking is completed in the target remote full-chain service contract on the second blockchain (for example, remote address locking is performed by invoking a full-chain contract protocol in the target remote full-chain service contract), remote address locking may be performed in the target full-chain service contract on the first blockchain, that is, the second blockchain node generates a contract locking request, and sends the contract locking request to the first blockchain node. For a process of performing remote address locking in the target remote full-chain service contract on the second blockchain, refer to related descriptions in the following embodiments.

S202: Obtain, from the contract locking request, a target remote contract address corresponding to the to-be-locked target remote full-chain service contract on the second blockchain.

The contract locking request may carry a blockchain identifier of the second blockchain and a target remote contract address corresponding to the target remote full-chain service contract on the second blockchain, and indicates that the target remote full-chain service contract on the second blockchain needs to be locked in the target full-chain service contract on the first blockchain, that is, the target remote contract address corresponding to the target remote full-chain service contract on the second blockchain is locked.

S203: Determine, in the target full-chain service contract by using a remote contract address locking mechanism associated with the target full-chain service contract, a remote contract address locking method for performing remote address locking on the target remote contract address, invoke the remote contract address locking method to perform remote address locking on the target remote contract address corresponding to the target remote full-chain service contract, and configure an address status of the target remote contract address after the remote address locking as an address locked status in the target full-chain service contract.

The target remote contract address in the address locked status suspends receiving a full-chain asset for cross-chain transfer that is sent by the first service object by using the target full-chain service contract. That is, in this case, the full-chain asset on the first blockchain cannot be transferred to the target remote full-chain service contract on the second blockchain by using the target full-chain service contract, that is, the contract is locked. In this way, the full-chain asset on the first blockchain is not lost.

In some embodiments, the first blockchain node may generate, after the remote address is locked, contract locking completion information corresponding to the contract locking request, and return the contract locking completion information to the second blockchain node, so that the second service object determines that remote address locking is performed on the target full-chain service contract on the first blockchain.

The remote contract address locking mechanism may be implemented by introducing a contract address locking function (for example, pauseMove (chainID)). In the contract address locking function, the chainID is a blockchain identifier of a to-be-locked service chain. That is, the chainID herein may be the blockchain identifier of the second blockchain. The contract address locking function represents a remote contract address locking method. By executing the contract address locking function, remote address locking may be performed on the target remote contract address associated with the blockchain identifier indicated by the chainID, and an address status of the target remote contract address after remote address locking is configured as an address locked status. This means that the service object on the first blockchain cannot transfer a full-chain asset to the second blockchain. By executing the contract address locking function indicated by the remote contract address locking method, it indicates that the target remote service contract on the second blockchain is locked in the target full-chain service contract on the first blockchain, or it may be described as locking the second blockchain in the target full-chain service contract on the first blockchain, or may be described as locking, in the target full-chain service contract on the first blockchain, the target remote contract address corresponding to the target remote service contract on the second blockchain. In addition, by executing the contract address locking function indicated by the remote contract address locking method, the address status of the target remote contract address is set to the address locked status.

An address locking operation is performed in the target full-chain service contract on the first blockchain, so that the full-chain asset on the first blockchain cannot be transferred to the second blockchain. Meanwhile, an address locking operation is performed in the target remote full-chain service contract on the second blockchain, so that reception of the full-chain asset transferred from the first blockchain to the second blockchain may be suspended. In this case, security update of the target remote full-chain service contract may be performed on the second blockchain.

In some embodiments, the target remote full-chain service contract in the contract update completion status is the updated target remote full-chain service contract, that is, a new target full-chain service contract on a second service when a contract status of the target remote full-chain service contract is adjusted from the contract update status to the contract update completion status. Meanwhile, a contract address of the updated target remote full-chain service contract is an updated target remote contract address, that is, a new contract address of the target full-chain service contract on the second service. Remote address locking needs to be performed on the target contract addresses of both the target remote full-chain service contract before update and the target remote full-chain service contract after update on the second blockchain. That is, the target contract address is in the address locked status in both the target remote full-chain service contract before update and the target remote full-chain service contract after update.

After the contract update of the target remote full-chain service contract deployed on the second blockchain is completed, a contract address of the updated target remote full-chain service contract needs to be set as a remote contract address in the target full-chain service contract on the first blockchain, and a contract address of the target full-chain service contract on the first blockchain needs to be set as a remote contract address in the target full-chain service contract on the second blockchain. That is, contract address binding is performed in the two full-chain service contracts. That is, after the contract update of the target remote full-chain service contract on the second blockchain is completed, the first blockchain node obtains a first contract binding request sent by the second service object for the updated target remote full-chain service contract deployed on the second blockchain. The first contract binding request is generated after the second service object performs remote address binding on the target contract address in the updated target remote full-chain service contract deployed on the second blockchain; the updated target remote contract address corresponding to the to-be-bound updated target remote full-chain service contract on the second blockchain is obtained from the first contract binding request; and a remote address setting interface is invoked by using the full-chain contract protocol in the target full-chain service contract, to set the updated target remote contract address as the remote contract address bound to the target full-chain service contract, so that the target remote full-chain service contract (in this case, a new target remote full-chain service contract) on the second blockchain is bound in the target full-chain service contract on the first blockchain. In operation S202 of the foregoing embodiment, the target remote contract address bound to the target full-chain service contract may be a contract address of a target remote full-chain service contract before update on the second blockchain, or may be a contract address of a new target remote full-chain service contract after update on the second blockchain.

In some embodiments, the first blockchain node may generate, after the remote address binding, contract binding completion information corresponding to the first contract binding request, and return the contract binding completion information to the second blockchain node, so that the second service object determines that the remote address binding is performed on the target full-chain service contract on the first blockchain.

Because the target remote contract address (that is, the contract address of the old target remote full-chain service contract) is locked previously, the full-chain asset on the first blockchain cannot be transferred to the second blockchain. In this case, the contract address of the updated target remote full-chain service contract on the second blockchain is also locked. Therefore, address unlocking needs to be performed herein, to restore asset circulation between the first blockchain and the second blockchain. That is, a first contract unlocking request sent by the second service object for the updated target remote full-chain service contract deployed on the second blockchain is obtained. The first contract unlocking request is generated after the second service object performs remote address unlocking on the target contract address in the updated target remote full-chain service contract deployed on the second blockchain, that is, the target full-chain service contract on the first blockchain is also unlocked in the updated target remote full-chain service contract on the second blockchain. The updated target remote contract address corresponding to the to-be-unlocked updated target remote full-chain service contract on the second blockchain is obtained from the first contract unlocking request. The first contract unlocking request may also carry the blockchain identifier of the second blockchain. A remote contract address unlocking method for performing remote address unlocking on the updated target remote contract address is determined in the target full-chain service contract by using a remote contract address unlocking mechanism (the remote contract address unlocking mechanism is used to unlock, in a target full-chain service contract on one service chain, a specified remote contract address on another service chain) associated with the target full-chain service contract, the remote contract address unlocking method is invoked to perform remote address unlocking on the updated target remote contract address corresponding to the updated target remote full-chain service contract, and an address status of the updated target remote contract address after the remote address unlocking is configured as an address unlocked status in the target full-chain service contract. The updated target remote contract address in the address unlocked status restarts receiving a full-chain asset for cross-chain transfer that is sent by the first service object by using the target full-chain service contract.

The remote contract address unlocking mechanism may be implemented by introducing a contract address unlocking function (for example, unpauseMove (chainID)). In the contract address unlocking function, the chainID may be a blockchain identifier of the service chain that is unlocked by using the contract address unlocking function. That is, the chainID herein may be a blockchain identifier of the second blockchain. The contract address unlocking function may be specifically a method that is used to perform address unlocking on a remote contract address of a target remote contract and that is included in a current service contract. By executing the contract address unlocking function, remote address unlocking may be performed on the target remote contract address associated with the blockchain identifier indicated by the chainID, and an address status of the target remote contract address after remote address unlocking is configured as an address unlocked status. This means that the service object on the first blockchain can restart transfer of a full-chain asset to the second blockchain. By executing the contract address unlocking function indicated by the remote contract address unlocking method, it indicates that the target remote service contract on the second blockchain is unlocked in the target full-chain service contract on the first blockchain, or it may be described as unlocking the second blockchain in the target full-chain service contract on the first blockchain, or may be described as unlocking, in the target full-chain service contract on the first blockchain, the updated target remote contract address corresponding to the updated target remote service contract on the second blockchain. In addition, by executing the contract address unlocking function indicated by the remote contract address unlocking method, the address status of the updated target remote contract address is set to the address unlocked status. The performing remote address unlocking on the updated target remote contract address corresponding to the updated target remote full-chain service contract may refer to: deleting the target remote contract address that is in the target full-chain service contract and on which the remote address locking is performed, and adding the target remote contract address to the target full-chain service contract.

In some embodiments, the first blockchain node may generate, after the remote address is unlocked, contract unlocking completion information corresponding to the first contract unlocking request, and return the contract unlocking completion information to the second blockchain node, so that the second service object determines that remote address unlocking is performed on the target full-chain service contract on the first blockchain.

An address unlocking operation is performed in the target full-chain service contract on the first blockchain, so that transfer of the full-chain asset from the first blockchain to the second blockchain may be restarted. Meanwhile, an address unlocking operation is performed in the updated target remote full-chain service contract on the second blockchain, so that reception of the full-chain asset transferred from the first blockchain to the second blockchain may be restarted. In this case, all procedures of updating the target remote full-chain service contract may be completed on the second blockchain, and the target remote full-chain service contract on the second blockchain is successfully replaced with the updated target remote full-chain service contract.

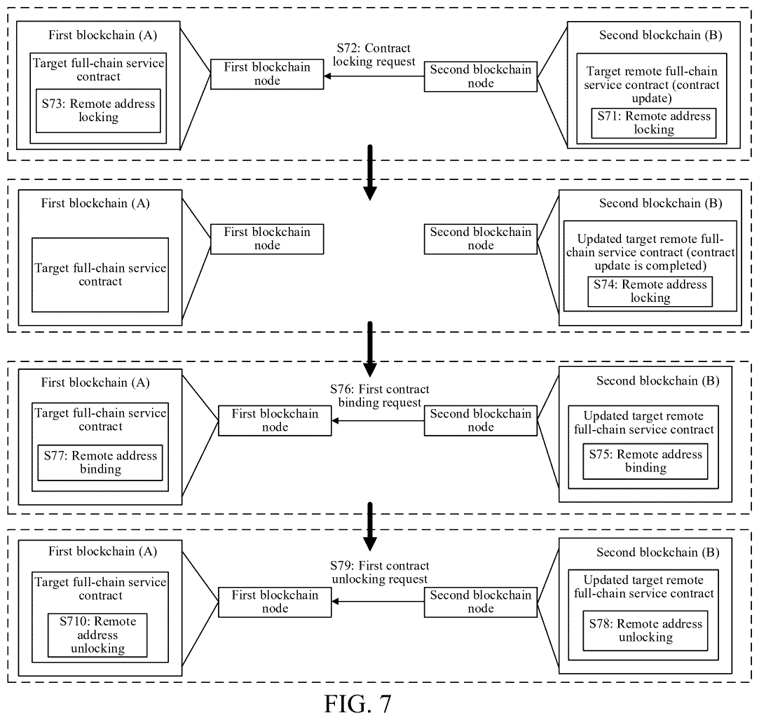

For example, FIG. 7 is a schematic diagram of a contract update scenario according to an embodiment of this disclosure. The blockchain identifier of the first blockchain is A, the blockchain identifier of the second blockchain is B, the contract address of the target full-chain service contract deployed on the first blockchain is a target contract address, and the contract address of the target remote full-chain service contract deployed on the second blockchain is a target remote contract address. S71: When a target remote full-chain service contract needs to be updated on a second blockchain, a second blockchain node first needs to execute pauseMove (A) in the target remote full-chain service contract of the second blockchain, to perform remote address locking on a target contract address in the target remote full-chain service contract on the second blockchain. S72: The second blockchain node may generate a contract locking request and send the contract locking request to a first blockchain node. S73: The first blockchain node executes pauseMove (B) in a target remote full-chain service contract of the first blockchain, to perform remote address locking on a target remote contract address in the target full-chain service contract of the first blockchain. S74: When the second blockchain node completes update of the target remote full-chain service contract on the second blockchain to obtain an updated target remote full-chain service contract, execute pauseMove (A) in the updated target remote full-chain service contract on the second blockchain, to perform remote address locking on a target contract address in the updated target remote full-chain service contract on the second blockchain, so that asset circulation temporarily cannot be performed through a target full-chain service on the first blockchain and the updated target remote full-chain service contract on the second blockchain.

S75: The second blockchain node performs remote contract address binding in the updated target remote full-chain service contract of the second blockchain, that is, sets a target contract address of the target full-chain service contract on the first blockchain as a remote contract address in the updated target remote full-chain service contract. S76: The second blockchain node may generate a first contract binding request and send the first contract binding request to the first blockchain node. S77: The first blockchain node performs remote contract address binding in the target full-chain service contract on the first blockchain based on the first contract binding request, that is, sets the updated target remote contract address corresponding to the updated target full-chain service contract on the second blockchain as a remote contract address in the target full-chain service contract.

S78: Perform contract unlocking on the updated target remote full-chain service contract and the target full-chain service contract. That is, the second blockchain node executes unpauseMove (A) in the updated target remote full-chain service contract on the second blockchain, to perform remote address unlocking on the updated target contract address in the updated target remote full-chain service contract on the second blockchain. S79: The second blockchain node may generate a first contract unlocking request and send the first contract unlocking request to the first blockchain node. S710: The first blockchain node executes unpauseMove (B) in the target remote full-chain service contract of the first blockchain, to perform remote address unlocking on the updated target remote contract address in the target full-chain service contract of the first blockchain, so that asset circulation can be restarted through the target full-chain service on the first blockchain and the updated target remote full-chain service contract on the second blockchain.

That is, a remote contract address locking mechanism may be used to implement a contract update process, and asset circulation may be automatically suspended, to ensure service consistency and asset security of the full-chain service contract in a setting process. Moreover, after remote contract address locking, asset circulation cannot be performed between the first blockchain and the second blockchain. An execution sequence of related operations on the first blockchain and the second blockchain may not be limited, and an asset on any service chain is not lost due to a specific execution sequence. For example, in the foregoing process, only after remote contract address binding is first completed in the updated target remote full-chain service contract on the second blockchain, remote contract address binding is completed in the target full-chain service contract on the first blockchain. In some embodiments, alternatively, only after remote contract address binding is first completed in the target full-chain service contract on the first blockchain, remote contract address binding is completed in the updated target remote full-chain service contract on the second blockchain. This is not limited herein.

The concept of the remote contract address is: A target full-chain service contract (for example, a contract a) on a service chain A and a target full-chain service contract (for example, a contract b) of the same type on a service chain B are set, and the contract b is a remote service contract of the contract a on the service chain B. That is, the contracts can manage the same type of full-chain asset. Therefore, a remote service contract needs to be set first, so that a target full-chain service contract on the service chain A can clearly correspond to the target full-chain service contract that manages the same type of full-chain asset and that is on the service chain B. In this way, cross-chain circulation of full-chain assets can be started. If a contract owner needs to update the contract a on the service chain A to a contract c, in such a scenario, full-chain flow of a full-chain asset in the target full-chain service contract may be first locked by using a remote contract address locking mechanism, and then contract update is performed, thereby protecting data consistency and security.

For example, a pauseMove function is introduced, and the pauseMove function accepts a blockchain identification parameter chainId. The service chain indicated by the chainId may be locked by using the pauseMove function. For example, pauseMove (B) is executed in the target full-chain service contract of the service chain A. This means that a service object on the service chain A cannot send a full-chain asset to the service chain B temporarily. By means of such a design, the contract owner can deal with an issue of updating the service contract in usage. Specifically, a contract owner may invoke pauseMove (A) in the target full-chain service contract of the service chain B. In this way, a service object on the service chain B cannot send a full-chain asset to the service chain A, but the service object on the service chain A can continue to send a full-chain asset to the service chain B. That is, in this case, the contract b can still be used to correctly receive the full-chain asset from the contract a. Then, the contract owner invokes pauseMove (B) in the contract a of the service chain A, and then the service object on the service chain A cannot send a full-chain asset to the service chain B either. Similarly, after the contract a on the service chain A is updated to the contract c, pauseMove (B) further needs to be invoked in the contract c on the service chain A. In this case, the contract owner may set remote contract addresses in the contract b and the contract c in any sequence. After determining that remote contract addresses in the contract c on the service chain A and the contract b on the service chain B are set, the contract owner invokes unPauseMove (B) in the contract c on the service chain A to perform address unlocking, and invokes unPauseMove (A) in the contract b on the service chain B to perform address unlocking, so that the service object on the service chain A can continue to send the full-chain asset to the service chain B. This design is also applicable to other scenarios. For example, when a full-chain asset that is deployed on the service chain A and that is already in usage needs to be deployed on the service chain B, the contract owner needs to first set, on the service chain B, a remote contract address corresponding to the service chain A; otherwise, the full-chain asset cannot be transferred. In this case, the contract owner may first invoke pauseMove (B) in the service contract of the service chain A and invoke pauseMove (A) in the service contract of the service chain B by using a remote contract address locking mechanism, and then set a contract address of a contract of the other party as a remote contract address in the service contract of the service chain A or the service contract of the service chain B, without worrying about impact caused by a remote address setting sequence.

When the multiple blockchains include the first blockchain, the second blockchain, and a third service chain, a contract update process on the second blockchain is similar to the foregoing process. That is, in contract update on the second blockchain, an interaction process between the second blockchain and the first blockchain is also performed between the second blockchain and the third service chain. Details are not described herein again.

In some embodiments, security verification may alternatively be performed by using an information management and verification service in an off-chain full-chain cross-chain service. For example, when determining that the remote contract address bound to the target full-chain service contract is updated, an updated target remote contract address to which the remote contract address bound to the target full-chain service contract is updated is used as an updated remote contract address. A key information disclosing interface is invoked by using the full-chain contract protocol in the target full-chain service contract, to obtain node port information associated with the updated remote contract address; and security verification is performed, by using an information management and verification service in an off-chain full-chain cross-chain service, on the node port information associated with the updated remote contract address. That is, each time it is detected that a remote contract address bound to a target full-chain service contract on a service chain changes, related information (for example, a port address and a contract address associated with the updated remote contract address) of the changed remote contract address may be disclosed by using the key information disclosing interface, so as to perform security verification on the related information of the changed remote contract address. Therefore, any service object and a third party can detect whether node port information comes from a tax chain authority, or whether a contract address is set correctly, or the like. Therefore, a third party can easily implement a check mechanism for full-chain contract correctness and a multi-chain binding relationship, to protect a service object from potential money loss.

That is, this disclosure provides a cross-chain mechanism for a full-chain asset (a cross-chain protocol for a full-chain asset), which can help a service party quickly start and deploy, on multiple blockchains, an asset that can be managed and circulated on the multiple blockchains at the same time. In addition, the cross-chain mechanism for a full-chain asset provides a standardized interface for service operations such as deployment of a target full-chain service contract and determining and transferring of a full-chain asset, and provides logical consistency and usage security of full-chain asset management and continuity of a full-chain asset between multiple chains. In addition, full-chain service transaction query may be implemented by using a unique full-chain event identifier, and convenience of a service of a full-chain asset is improved by using token airdrop support of the full-chain token airdrop contract. In addition, by means of features such as the remote contract address locking mechanism and the node port information disclosing mechanism, higher security is provided for a service of a full-chain asset. In addition, cross-chain interoperability and combinability of a full-chain asset can be implemented, a new design field and possibility of an encrypted network are unlocked, and cross-chain costs of a full-chain asset are reduced. That is, in a service scenario including multiple chains, a full-chain asset cross-chain protocol adapted to multiple chains is provided, and a service contract is allowed to be accessed in a mode of “full-chain contract”. That is, a target full-chain service contract deployed on each service chain is integrated with the same full-chain contract protocol, and a standard contract protocol and cross-chain service are provided to implement full-chain allocation and transfer of a full-chain asset.

In this embodiment of this disclosure, a remote contract address locking mechanism is provided, so that a remote contract address may be locked when a contract is updated, to prevent an asset loss caused by circulation of a full-chain asset when updating a contract in usage, thereby ensuring asset security on the chain.

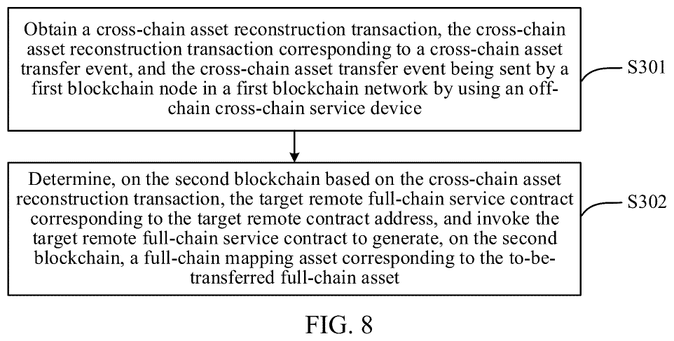

Further, FIG. 8 is a schematic flowchart of a data processing method based on multiple blockchains according to an embodiment of this disclosure. As shown in FIG. 8, the method may be performed by the second blockchain node in the second blockchain network. For example, the second blockchain node may be any blockchain node in the second blockchain network 300 shown in FIG. 1. The method may specifically include the following operation S301 and operation S302.

S301: Obtain a cross-chain asset reconstruction transaction, the cross-chain asset reconstruction transaction corresponding to a cross-chain asset transfer event, and the cross-chain asset transfer event being sent by a first blockchain node in a first blockchain network by using an off-chain cross-chain service device.

The cross-chain asset reconstruction transaction is a transaction in the cross-chain transaction request sent by the off-chain cross-chain service device. The cross-chain asset reconstruction transaction may be constructed according to the cross-chain asset transfer transaction indicated by the cross-chain asset transfer event. Then, the constructed cross-chain asset reconstruction transaction has a correspondence with the cross-chain asset transfer event indicating the cross-chain asset transfer transaction on which the construction is based. The cross-chain asset transfer event is an event instructing to perform the cross-chain asset transfer transaction. The cross-chain asset transfer transaction is a transaction instructing to perform cross-chain asset transfer. Cross-chain asset transfer may be a digital asset transfer transaction based on the first blockchain and the second blockchain, or may be digital asset transfer in which the first blockchain and the second blockchain both participate. The cross-chain asset transfer transaction may be generated by the first blockchain node based on a target remote contract address bound to a target full-chain service contract and a to-be-transferred full-chain asset. The target remote contract address is obtained by the first blockchain node by using a full-chain contract protocol in the target full-chain service contract. The to-be-transferred full-chain asset is a full-chain asset that is associated with the cross-chain asset transfer transaction and that is determined by invoking the target full-chain service contract when the first blockchain node obtains a full-chain asset transfer request sent by a first service object for a service transaction and determines, based on the full-chain asset transfer request, that the service transaction is a cross-chain asset transfer transaction. The target full-chain service contract is a full-chain service contract that is on the first blockchain and integrated with the full-chain contract protocol. A remote full-chain service contract corresponding to the target remote contract address is a full-chain service contract that is on the second blockchain and integrated with the full-chain contract protocol.

S302: Determine, on the second blockchain based on the cross-chain asset reconstruction transaction, the target remote full-chain service contract corresponding to the target remote contract address, and invoke the target remote full-chain service contract to generate, on the second blockchain, a full-chain mapping asset corresponding to the to-be-transferred full-chain asset.

Asset data information of the full-chain mapping asset is the same as asset data information of the target full-chain asset, and asset content of the full-chain mapping asset is the same as asset content of the target full-chain asset.

The invoking the target remote full-chain service contract to generate, on the second blockchain, a full-chain mapping asset corresponding to the to-be-transferred full-chain asset may be: invoking the target remote full-chain service contract to perform transaction verification on the cross-chain asset reconstruction transaction to obtain a transaction verification result; determining a determined asset having the same asset content and the same asset data information as the to-be-transferred full-chain asset on the second blockchain when the transaction verification result indicates that transaction verification succeeds, and using the determined asset as the full-chain mapping asset. In this case, transfer of the full-chain asset from the first blockchain to the second blockchain may be completed, that is, full-chain circulation of the full-chain asset may be completed.

The cross-chain transaction request carries transaction signature information obtained by the off-chain cross-chain service device by signing the cross-chain asset reconstruction transaction by using private key information. The invoking the target remote full-chain service contract to perform transaction verification on the cross-chain asset reconstruction transaction to obtain a transaction verification result may be: using the cross-chain asset reconstruction transaction obtained from the cross-chain transaction request as a to-be-compared transaction; invoking a target remote full-chain service contract to obtain public key information corresponding to private key information of an off-chain cross-chain service device, performing signature verification on the transaction signature information according to the public key information, and using the cross-chain asset reconstruction transaction corresponding to the transaction signature information as a to-be-matched transaction when the signature verification succeeds; and performing transaction comparison on the to-be-compared transaction and the to-be-matched transaction, to obtain a transaction comparison result, and using the transaction comparison result as the transaction verification result.

The cross-chain asset reconstruction transaction carries a to-be-airdropped full-chain token, and the to-be-airdropped full-chain token is a first blockchain token obtained by the first blockchain node for the to-be-transferred full-chain asset by using a full-chain token airdrop contract on the first blockchain. Therefore, when the target remote full-chain service contract is invoked to generate, on the second blockchain, the full-chain mapping asset corresponding to the to-be-transferred full-chain asset, the second blockchain node may further invoke a full-chain token airdrop contract on the second blockchain by using the target remote full-chain service contract, to determine a second blockchain airdrop token corresponding to the to-be-airdropped full-chain token, and allocate the second blockchain airdrop token to a service object corresponding to the full-chain mapping asset. The service object corresponding to the full-chain mapping asset may be the first service object or another object. The second blockchain airdrop token is used to support the service object corresponding to the full-chain mapping asset, to perform a service operation on the full-chain mapping asset on the second blockchain, so that in cross-chain transfer of the full-chain asset, the first blockchain token on the first blockchain is airdropped to the second blockchain to serve as a basic token of the full-chain mapping asset.

In some embodiments, when the target remote full-chain service contract on the second blockchain needs to be updated, a remote contract address locking mechanism may be used. This may be specifically: obtaining a contract update request that is sent by a second service object for the target remote full-chain service contract, performing contract update processing on the target remote full-chain service contract based on the contract update request, and setting a contract status of the target remote full-chain service contract to a contract update status, where the second service object is a service object that is on the second blockchain and that corresponds to the target remote full-chain service contract, for example, may be a contract owner of the target remote full-chain service contract; obtaining a target contract address that corresponds to the to-be-locked target full-chain service contract and that is on the first blockchain when detecting that the target remote full-chain service contract is in the contract update status; and determining, in the target remote full-chain service contract by using a remote contract address locking mechanism associated with the target remote full-chain service contract, a remote contract address locking method for performing remote address locking on the target contract address, invoking the remote contract address locking method to perform remote address locking on the target contract address, and configuring an address status of the target contract address after the remote address locking as an address locked status in the target remote full-chain service contract, where the target contract address in the address locked status suspends receiving a full-chain asset for cross-chain transfer that is sent by using the updated target remote full-chain service contract. That is, in this case, the full-chain asset on the second blockchain cannot be transferred to the first blockchain. For specific descriptions and principles of the remote contract address locking mechanism, refer to the related descriptions in the foregoing embodiments.

When performing remote address locking on the target contract address of the target full-chain service contract, the second blockchain node may generate a contract locking request that is sent for the target remote full-chain service contract deployed on the second blockchain, and send the contract locking request to the first blockchain node, so that the first blockchain node performs remote address locking on the target remote contract address of the target remote full-chain service contract in the target full-chain service contract deployed on the first blockchain. The first blockchain node may generate, after the remote address is locked, contract locking completion information corresponding to the contract locking request, and return the contract locking completion information to the second blockchain node, so that the second service object determines that remote address locking is performed on the target full-chain service contract on the first blockchain.

Meanwhile, the second blockchain node may perform contract update on the target remote full-chain service contract on the second blockchain. When the contract update is completed, the target remote full-chain service contract is adjusted from the contract update status to a contract update completion status. Therefore, the target remote full-chain service contract in a contract update completion status is used as the updated target remote full-chain service contract when it is detected that a contract status of the target remote full-chain service contract is adjusted from the contract update status to the contract update completion status. A target contract address that corresponds to the to-be-locked target full-chain service contract and that is on the first blockchain is obtained. A remote contract address locking method for performing remote address locking on the target contract address is determined in the updated target remote full-chain service contract by using a remote contract address locking mechanism associated with the updated target remote full-chain service contract. The remote contract address locking method is invoked to perform remote address locking on the target contract address, and an address status of the target contract address after the remote address locking is configured as an address locked status in the updated target remote full-chain service contract, where the target contract address in the address locked status suspends receiving a full-chain asset for cross-chain transfer that is sent by using the updated target remote full-chain service contract. That is, for the updated target remote full-chain service contract, remote address locking also needs to be performed on the target contract address of the target full-chain service contract.

After the second service object determines that contract update of the target remote full-chain service contract on the second blockchain is completed, the remote address locking is performed on the target full-chain service contract on the first blockchain, and the remote address locking is performed on the updated target remote full-chain service contract on the second blockchain, remote address binding may be performed. For example, the second service object may implement this by initiating a second contract binding request. This may be specifically: obtaining a second contract binding request that is sent by the second service object for the updated target remote full-chain service contract, and obtaining, from the second contract binding request, the target contract address corresponding to the to-be-bound target full-chain service contract on the first blockchain; and invoking a remote address setting interface by using the full-chain contract protocol in the target remote full-chain service contract, to set the target contract address as the remote contract address bound to the updated target remote full-chain service contract. That is, the target contract address is bound in the updated target remote full-chain service contract.

The second blockchain node may further generate a first contract binding request that is sent by the second service object for the updated target remote full-chain service contract deployed on the second blockchain, and send the first contract binding request to the first blockchain node, so that the first blockchain node performs, in the target full-chain service contract deployed on the first blockchain, remote address binding on the updated target remote contract address corresponding to the updated target remote full-chain service contract. In some embodiments, the first blockchain node may generate, after the remote address binding, contract binding completion information corresponding to the first contract binding request, and return the contract binding completion information to the second blockchain node, so that the second service object determines that the remote address binding is performed on the target full-chain service contract on the first blockchain.

After the second service object determines that the remote address binding is performed on the target full-chain service contract on the first blockchain and the remote address binding is performed on the updated target remote full-chain service contract on the second blockchain, remote address unlocking may be performed. For example, the second service object may implement this by initiating a second contract unlocking request. This may be specifically: obtaining a second contract unlocking request that is sent by the second service object for the updated target remote full-chain service contract, and obtaining, from the second contract unlocking request, the target contract address corresponding to the to-be-unlocked target full-chain service contract on the first blockchain; and determining, in the updated target remote full-chain service contract by using a remote contract address unlocking mechanism associated with the updated target remote full-chain service contract, a remote contract address unlocking method for performing remote address unlocking on the target contract address, invoking the remote contract address unlocking method to perform remote address unlocking on the target contract address corresponding to the target full-chain service contract, and configuring an address status of the target contract address after the remote address unlocking as an address unlocked status in the updated target remote full-chain service contract, where the target contract address in the address unlocked status restarts receiving a full-chain asset for cross-chain transfer that is sent by using the updated target remote full-chain service contract. That is, the target contract address is unlocked in the updated target remote full-chain service contract. For specific descriptions and principles of the remote contract address unlocking mechanism, refer to the related descriptions of the foregoing embodiments.

The second blockchain node may further generate a first contract unlocking request that is sent by the second service object for the updated target remote full-chain service contract deployed on the second blockchain, and send the first contract unlocking request to the first blockchain node, so that the first blockchain node performs, in the target full-chain service contract deployed on the first blockchain, remote address unlocking on the updated target remote contract address corresponding to the updated target remote full-chain service contract. In some embodiments, the first blockchain node may generate, after the remote address is unlocked, contract unlocking completion information corresponding to the first contract unlocking request, and return the contract unlocking completion information to the second blockchain node, so that the second service object determines that remote address unlocking is performed on the target full-chain service contract on the first blockchain.

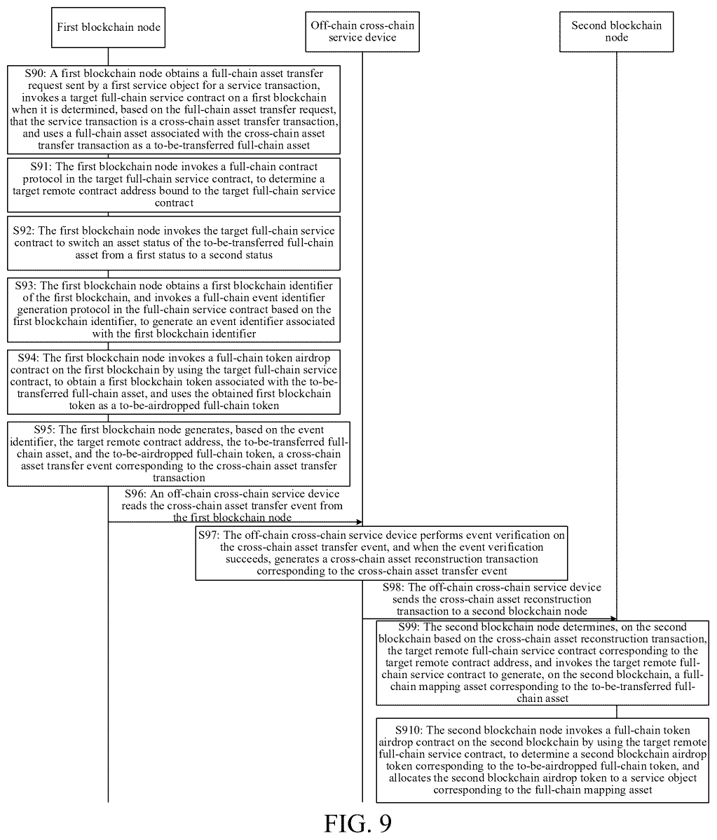

For example, FIG. 9 is a schematic interaction diagram of data processing based on multiple blockchains according to an embodiment of this disclosure. S90: A first blockchain node obtains a full-chain asset transfer request sent by a first service object for a service transaction, invokes a target full-chain service contract on a first blockchain when it is determined, based on the full-chain asset transfer request, that the service transaction is a cross-chain asset transfer transaction, and uses a full-chain asset associated with the cross-chain asset transfer transaction as a to-be-transferred full-chain asset. S91: The first blockchain node invokes a full-chain contract protocol in the target full-chain service contract, to determine a target remote contract address bound to the target full-chain service contract. S92: The first blockchain node invokes the target full-chain service contract to switch an asset status of the to-be-transferred full-chain asset from a first status to a second status. S93: The first blockchain node obtains a first blockchain identifier of the first blockchain, and invokes a full-chain event identifier generation protocol in the full-chain service contract based on the first blockchain identifier, to generate an event identifier associated with the first blockchain identifier. S94: The first blockchain node invokes a full-chain token airdrop contract on the first blockchain by using the target full-chain service contract, to obtain a first blockchain token associated with the to-be-transferred full-chain asset, and uses the obtained first blockchain token as a to-be-airdropped full-chain token. S95: The first blockchain node generates, based on the event identifier, the target remote contract address, the to-be-transferred full-chain asset, and the to-be-airdropped full-chain token, a cross-chain asset transfer event corresponding to the cross-chain asset transfer transaction. S96: An off-chain cross-chain service device reads the cross-chain asset transfer event from the first blockchain node. S97: The off-chain cross-chain service device performs event verification on the cross-chain asset transfer event, and when the event verification succeeds, generates a cross-chain asset reconstruction transaction corresponding to the cross-chain asset transfer event. S98: The off-chain cross-chain service device sends the cross-chain asset reconstruction transaction to a second blockchain node. S99: The second blockchain node determines, on the second blockchain based on the cross-chain asset reconstruction transaction, the target remote full-chain service contract corresponding to the target remote contract address, and invokes the target remote full-chain service contract to generate, on the second blockchain, a full-chain mapping asset corresponding to the to-be-transferred full-chain asset. S910: The second blockchain node invokes a full-chain token airdrop contract on the second blockchain by using the target remote full-chain service contract, to determine a second blockchain airdrop token corresponding to the to-be-airdropped full-chain token, and allocates the second blockchain airdrop token to a service object corresponding to the full-chain mapping asset.

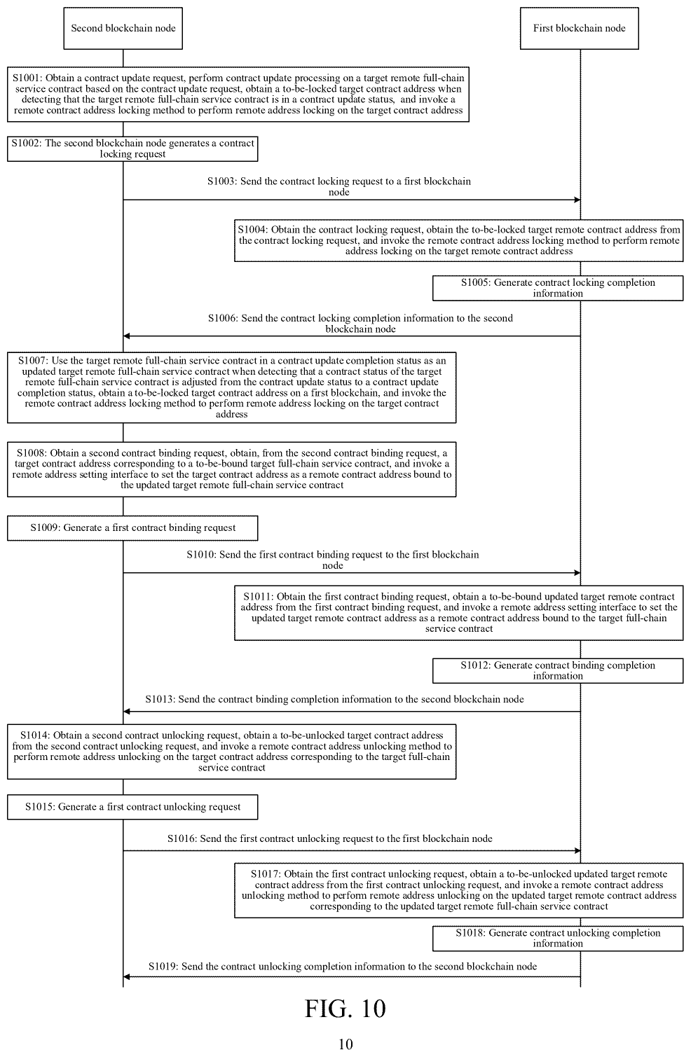

For another example, FIG. 10 is a schematic interaction diagram of contract update according to an embodiment of this disclosure. S1001: A second blockchain node obtains a contract update request, performs contract update processing on a target remote full-chain service contract based on the contract update request, obtains a to-be-locked target contract address when detecting that the target remote full-chain service contract is in a contract update status, and invokes a remote contract address locking method to perform remote address locking on the target contract address. S1002: The second blockchain node generates a contract locking request. S1003: The second blockchain node sends the contract locking request to a first blockchain node. S1004: The first blockchain node obtains the contract locking request, obtains the to-be-locked target remote contract address from the contract locking request, and invokes the remote contract address locking method to perform remote address locking on the target remote contract address. S1005: The first blockchain node generates contract locking completion information. S1006: The first blockchain node sends the contract locking completion information to the second blockchain node. S1007: The second blockchain node uses the target remote full-chain service contract in a contract update completion status as an updated target remote full-chain service contract when detecting that a contract status of the target remote full-chain service contract is adjusted from the contract update status to a contract update completion status, obtains a to-be-locked target contract address on a first blockchain, and invokes the remote contract address locking method to perform remote address locking on the target contract address. S1008: The second blockchain node obtains a second contract binding request, obtains, from the second contract binding request, a target contract address corresponding to a to-be-bound target full-chain service contract, and invokes a remote address setting interface to set the target contract address as a remote contract address bound to the updated target remote full-chain service contract. S1009: The second blockchain node generates a first contract binding request. S1010: The second blockchain node sends the first contract binding request to the first blockchain node. S1011: The first blockchain node obtains the first contract binding request, obtains a to-be-bound updated target remote contract address from the first contract binding request, and invokes a remote address setting interface to set the updated target remote contract address as a remote contract address bound to the target full-chain service contract. S1012: The first blockchain node generates contract binding completion information. S1013: The first blockchain node sends the contract binding completion information to the second blockchain node. S1014: The second blockchain node obtains a second contract unlocking request, obtains a to-be-unlocked target contract address from the second contract unlocking request, and invokes a remote contract address unlocking method to perform remote address unlocking on the target contract address corresponding to the target full-chain service contract. S1015: The second blockchain node generates a first contract unlocking request. S1016: The second blockchain node sends the first contract unlocking request to the first blockchain node. S1017: The first blockchain node obtains the first contract unlocking request, obtains a to-be-unlocked updated target remote contract address from the first contract unlocking request, and invokes a remote contract address unlocking method to perform remote address unlocking on the updated target remote contract address corresponding to the updated target remote full-chain service contract. S1018: The first blockchain node generates contract unlocking completion information. S1019: The first blockchain node sends the contract unlocking completion information to the second blockchain node.

In this embodiment of this disclosure, the multiple blockchains may include a first blockchain and a second blockchain. A cross-chain asset transfer transaction corresponding to a full-chain asset transfer request is used to instruct to transfer a to-be-transferred full-chain asset (which is, for example, a digital asset and may be specifically a digital collection) from the first blockchain to the second blockchain. In this solution, a full-chain service contract integrated with the same full-chain contract protocol may be deployed on the first blockchain and the second blockchain to implement cross-chain transfer of the to-be-transferred full-chain asset. The target full-chain service contract for executing the cross-chain asset transfer transaction is deployed on the first blockchain, and a full-chain service contract that corresponds to the target full-chain service contract and that is on the second blockchain is a target remote full-chain service contract. The target full-chain service contract and the target remote full-chain service contract are integrated with the same full-chain contract protocol, that is, the target full-chain service contract and the target remote full-chain service contract are integrated with the same asset transfer method (for example, an asset transfer related method or an asset determining related method), that is, an asset determining rule on the first blockchain is the same as an asset determining rule on the second blockchain. Therefore, the first blockchain node may invoke the full-chain contract protocol in the target full-chain service contract to generate a cross-chain asset transfer event corresponding to the cross-chain asset transfer transaction, to implement cross-chain transfer of the to-be-transferred full-chain asset. The second blockchain node may invoke the full-chain contract protocol in the target remote full-chain service contract based on the cross-chain asset reconstruction transaction corresponding to the cross-chain asset transfer event, to determine the to-be-transferred full-chain asset. Because the first blockchain node and the second blockchain node transfer and determine the digital asset by using an asset transfer method uniformly specified in the same full-chain contract protocol, asset data information of the full-chain mapping asset determined by the second blockchain node may be the same as asset data information of the to-be-transferred full-chain asset. In this case, the to-be-transferred full-chain asset on the first blockchain and the mapping asset on the second blockchain may be considered as the same asset. In this way, full-chain circulation of the same digital asset may be securely implemented between different blockchains, thereby improving mobility of digital asset between multiple blockchains.

Further, FIG. 11 is a schematic structural diagram of a data processing apparatus based on multiple blockchains according to an embodiment of this disclosure. As shown in FIG. 11, the data processing apparatus 1 based on multiple blockchains may be applied to a computer device. The data processing apparatus 1 based on multiple blockchains may be a computer-readable instruction running in a computer device. For example, the data processing apparatus 1 based on multiple blockchains may be application software. The data processing apparatus 1 based on multiple blockchains may be configured to perform the corresponding operations in the method provided in the embodiments of this disclosure. As shown in FIG. 11, the data processing apparatus 1 based on multiple blockchains may include: a full-chain asset obtaining module 11, a contract address determining module 12, and a transfer event generation module 13.

The full-chain asset obtaining module 11 is configured to: obtain a full-chain asset transfer request sent by a first service object for a service transaction, invoke a target full-chain service contract on the first blockchain when it is determined, based on the full-chain asset transfer request, that the service transaction is a cross-chain asset transfer transaction, and use a full-chain asset associated with the cross-chain asset transfer transaction as a to-be-transferred full-chain asset, the cross-chain asset transfer transaction being used to instruct to transfer the to-be-transferred full-chain asset from the first blockchain to the second blockchain.

The contract address determining module 12 is configured to: invoke a full-chain contract protocol in the target full-chain service contract, to determine a target remote contract address bound to the target full-chain service contract, the full-chain contract protocol being determined based on a full-chain contract protocol interface provided by a full-chain service parent contract on the first blockchain, and a target remote full-chain service contract corresponding to the target remote contract address being a full-chain service contract that is on the second blockchain and integrated with the full-chain contract protocol.

The transfer event generation module 13 is configured to transmit, by using an off-chain cross-chain service device, a cross-chain asset reconstruction transaction corresponding to a cross-chain asset transfer event to a second blockchain node in the second blockchain network when generating, based on the target remote contract address and the to-be-transferred full-chain asset, the cross-chain asset transfer event corresponding to the cross-chain asset transfer transaction, so that the second blockchain node determines, on the second blockchain based on the cross-chain asset reconstruction transaction, the target remote full-chain service contract corresponding to the target remote contract address, and invokes the target remote full-chain service contract to generate, on the second blockchain, a full-chain mapping asset corresponding to the to-be-transferred full-chain asset, asset data information of the full-chain mapping asset being the same as asset data information of the to-be-transferred full-chain resource.

The cross-chain asset transfer transaction carries a second blockchain identifier of the second blockchain.

The contract address determining module 12 includes:
a contract address obtaining unit 121, configured to invoke the full-chain contract protocol in the target full-chain service contract, to obtain the remote contract address bound to the target full-chain service contract, where the remote contract address bound to the target full-chain service contract includes a contract address corresponding to a full-chain service contract that is on a reference service chain and integrated with the full-chain contract protocol; the reference service chain is a blockchain of the multiple blockchains other than the first blockchain; and the reference service chain includes the second blockchain; and
a contract address determining unit 122, configured to determine a remote contract address associated with the second blockchain identifier as the target remote contract address in the remote contract address bound to the target full-chain service contract.

The transfer event generation module 13 includes:
a status switching unit 131, configured to invoke the target full-chain service contract to switch an asset status of the to-be-transferred full-chain asset from a first status to a second status, where the second status is an asset locked status; and
a transfer event generation unit 132, configured to: when the asset status of the to-be-transferred full-chain asset is the second status, generate, based on the target remote contract address and the to-be-transferred full-chain asset, the cross-chain asset transfer event corresponding to the cross-chain asset transfer transaction.

The transfer event generation module 13 includes:
a blockchain identifier obtaining unit 133, configured to obtain a first blockchain identifier of the first blockchain; where the first blockchain identifier is a blockchain identifier configured for the first blockchain through a unified full-chain registration service in an off-chain full-chain cross-chain service; and
a blockchain identifier generation unit 134, configured to invoke a full-chain event identifier generation protocol in the full-chain service contract based on the first blockchain identifier, to generate an event identifier associated with the first blockchain identifier.

The transfer event generation unit 132 is further configured to generate, based on the event identifier, the target remote contract address, and the to-be-transferred full-chain asset, the cross-chain asset transfer event corresponding to the cross-chain asset transfer transaction.

The cross-chain asset transfer event carries an asset identifier of the to-be-transferred full-chain asset, and the asset identifier of the to-be-transferred full-chain asset is generated based on an identifier prefix associated with the first blockchain and an asset identifier template configured in the full-chain contract protocol. The cross-chain asset reconstruction transaction corresponding to the cross-chain asset transfer event is constructed when the off-chain cross-chain service device performs, based on the identifier prefix and the asset identifier template, identifier verification on the asset identifier of the to-be-transferred full-chain asset carried in the cross-chain asset transfer event and succeeds in the identifier verification.

The transfer event generation module 13 further includes:
a full-chain token obtaining unit 135, configured to invoke a full-chain token airdrop contract on the first blockchain by using the target full-chain service contract, to obtain a first blockchain token associated with the to-be-transferred full-chain asset, and use the obtained first blockchain token as a to-be-airdropped full-chain token; and
a full-chain token writing unit 136, configured to write the to-be-airdropped full-chain token into the cross-chain asset transfer event when the cross-chain asset transfer event corresponding to the cross-chain asset transfer transaction is generated.

The to-be-transferred full-chain asset is some or all of full-chain assets for cross-chain transfer determined on the first blockchain.

The full-chain asset obtaining module 11 further includes:
a determining request obtaining unit 111, configured to obtain a full-chain asset determining request for a full-chain asset determining transaction, invoke the target full-chain service contract on the first blockchain based on the full-chain asset determining request, and determine a determined asset quantity of the full-chain asset determining transaction as a to-be-determined asset quantity;
an asset identifier generation unit 112, configured to invoke the full-chain contract protocol in the target full-chain service contract, to obtain the identifier prefix associated with the first blockchain, and generate, based on the identifier prefix associated with the first blockchain and the asset identifier template configured in the full-chain contract protocol, a to-be-determined full-chain asset identifier corresponding to the to-be-determined asset quantity, where the to-be-determined full-chain asset identifier includes the identifier prefix associated with the first blockchain; and
a full-chain asset determining unit 113, configured to invoke an asset determining contract in the target full-chain service contract, to determine, on the first blockchain, a full-chain asset corresponding to the to-be-determined full-chain asset identifier, and use the determined full-chain asset as a full-chain asset for cross-chain transfer determined on the first blockchain.

The contract address determining module 12 further includes:
a locking request obtaining unit 123, configured to obtain a contract locking request sent by a second service object for a target remote full-chain service contract deployed on a second blockchain; where the second service object is a service object that is on the second blockchain and that corresponds to the target remote full-chain service contract, and the contract locking request is generated after the second service object performs, in the target remote full-chain service contract deployed on the second blockchain, remote address locking on a contract address corresponding to the target full-chain service contract;
an address obtaining unit 124, configured to obtain, from the contract locking request, the target remote contract address corresponding to the to-be-locked target remote full-chain service contract on the second blockchain; and
a remote address locking unit 125, configured to determine, in the target full-chain service contract by using a remote contract address locking mechanism associated with the target full-chain service contract, a remote contract address locking method for performing remote address locking on the target remote contract address, invoke the remote contract address locking method to perform remote address locking on the target remote contract address corresponding to the target remote full-chain service contract, and configure an address status of the target remote contract address after the remote address locking as an address locked status in the target full-chain service contract; where the target remote contract address in the address locked status suspends receiving a full-chain asset for cross-chain transfer that is sent by the first service object by using the target full-chain service contract.

The target remote full-chain service contract in a contract update completion status is the updated target remote full-chain service contract when a contract status of the target remote full-chain service contract is adjusted from the contract update status to the contract update completion status. A contract address of the updated target remote full-chain service contract is the updated target remote contract address.

The contract address determining module 12 further includes:
a binding request obtaining unit 126, configured to obtain a first contract binding request that is sent by the second service object for the updated target remote full-chain service contract deployed on the second blockchain, where the first contract binding request is generated after the second service object performs remote address binding on the target contract address in the updated target remote full-chain service contract deployed on the second blockchain; where
the address obtaining unit 124 is further configured to obtain, from the first contract binding request, the updated target remote contract address corresponding to the to-be-bound updated target remote full-chain service contract on the second blockchain; and
a remote address binding unit 127, configured to invoke a remote address setting interface by using the full-chain contract protocol in the target full-chain service contract, to set the updated target remote contract address as the remote contract address bound to the target full-chain service contract.

The contract address determining module 12 further includes:
an unlocking request obtaining unit 128, configured to obtain a first contract unlocking request that is sent by the second service object for the updated target remote full-chain service contract deployed on the second blockchain, where the first contract unlocking request is generated after the second service object performs remote address unlocking on the target contract address in the updated target remote full-chain service contract deployed on the second blockchain; where
the address obtaining unit 124 is further configured to obtain, from the first contract unlocking request, the updated target remote contract address corresponding to the to-be-unlocked updated target remote full-chain service contract on the second blockchain; and
a remote address unlocking unit 129, configured to determine, in the target full-chain service contract by using a remote contract address unlocking mechanism associated with the target full-chain service contract, a remote contract address unlocking method for performing remote address unlocking on the updated target remote contract address, invoke the remote contract address unlocking method to perform remote address unlocking on the updated target remote contract address corresponding to the updated target remote full-chain service contract, and configure an address status of the updated target remote contract address after the remote address unlocking as an address unlocked status in the target full-chain service contract, where the updated target remote contract address in the address unlocked status restarts receiving a full-chain asset for cross-chain transfer that is sent by the first service object by using the target full-chain service contract.

The contract address determining module 12 further includes:
an information verification unit 1210, configured to: when determining that the remote contract address bound to the target full-chain service contract is updated, use, as an updated remote contract address, an updated target remote contract address to which the remote contract address bound to the target full-chain service contract is updated.

The information verification unit 1210 is further configured to invoke a key information disclosing interface by using the full-chain contract protocol in the target full-chain service contract, to obtain node port information associated with the updated remote contract address.

The information verification unit 1210 is further configured to perform, by using an information management and verification service in an off-chain full-chain cross-chain service, security verification on the node port information associated with the updated remote contract address.

The transfer event generation module 13 is specifically configured to:
read, by using an off-chain cross-chain service device, the cross-chain asset transfer event that is associated with the target full-chain service contract and that is generated in a target cycle, where when reading the cross-chain asset transfer event associated with the target full-chain service contract, the off-chain cross-chain service device is configured to perform event verification on the cross-chain asset transfer event by using the cross-chain event verification and forwarding service in the off-chain full-chain cross-chain service, and for the cross-chain asset transfer event for which the event verification succeeds, forward a cross-chain asset reconstruction transaction corresponding to the cross-chain asset transfer event.

Specific implementations of the full-chain asset obtaining module 11, the contract address determining module 12, and the transfer event generation module 13 can be found in the related descriptions of the above embodiments. Details are not described herein again. The descriptions of beneficial effects obtained by using the same method are not described herein in detail again.

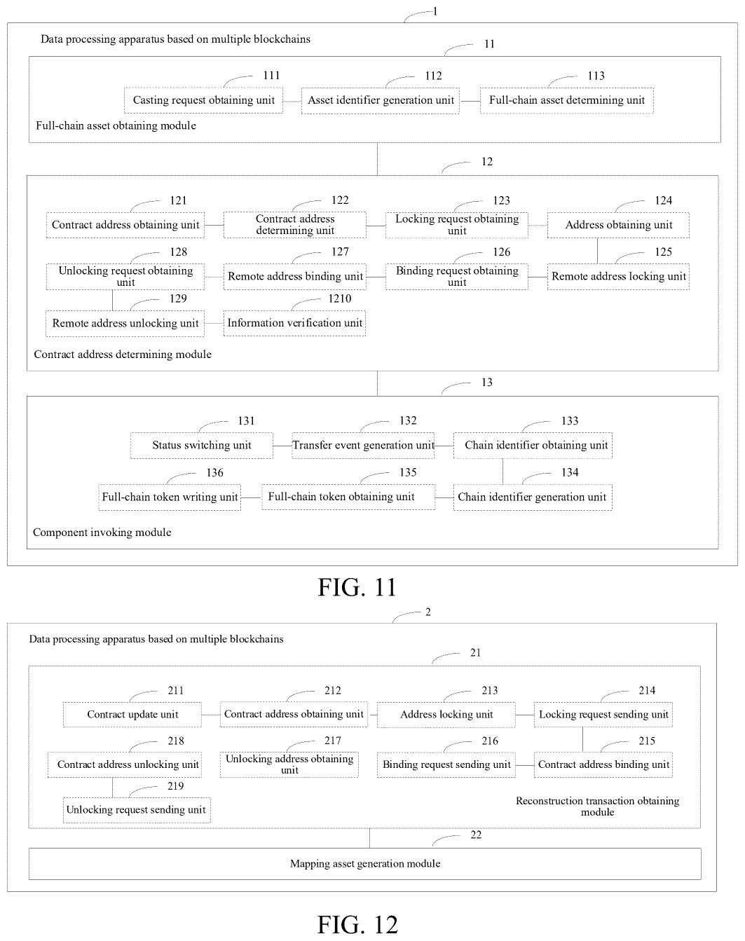

Further, FIG. 12 is a schematic structural diagram of a data processing apparatus based on multiple blockchains according to an embodiment of this disclosure. As shown in FIG. 12, the data processing apparatus 2 based on multiple blockchains may be applied to a computer device. The data processing apparatus 2 based on multiple blockchains may be a computer-readable instruction running in a computer device. For example, the data processing apparatus 2 based on multiple blockchains may be application software. The data processing apparatus 2 based on multiple blockchains may be configured to perform the corresponding operations in the method provided in the embodiments of this disclosure. As shown in FIG. 12, the data processing apparatus 2 based on multiple blockchains may include: a reconstruction transaction obtaining module 21 and a mapping asset generation module 22.

The reconstruction transaction obtaining module 21 is configured to obtain a cross-chain asset reconstruction transaction, the cross-chain asset reconstruction transaction corresponding to a cross-chain asset transfer event, the cross-chain asset transfer event being sent by a first blockchain node in the first blockchain network by using an off-chain cross-chain service device, the cross-chain asset transfer event being an event that corresponds to a cross-chain asset transfer transaction and that is generated by the first blockchain node based on a target remote contract address bound to a target full-chain service contract and a to-be-transferred full-chain asset, the target remote contract address being obtained by the first blockchain node by using a full-chain contract protocol in the target full-chain service contract, the to-be-transferred full-chain asset being a full-chain asset that is associated with the cross-chain asset transfer transaction and that is determined by invoking the target full-chain service contract when the first blockchain node obtains a full-chain asset transfer request sent by a first service object for a service transaction and determines, based on the full-chain asset transfer request, that the service transaction is a cross-chain asset transfer transaction, the target full-chain service contract being a full-chain service contract that is on the first blockchain and integrated with the full-chain contract protocol, and a remote full-chain service contract corresponding to the target remote contract address being a full-chain service contract that is on the second blockchain and integrated with the full-chain contract protocol.

The mapping asset generation module 22 is configured to: determine, on the second blockchain based on the cross-chain asset reconstruction transaction, the target remote full-chain service contract corresponding to the target remote contract address, and invoke the target remote full-chain service contract to generate, on the second blockchain, a full-chain mapping asset corresponding to the to-be-transferred full-chain asset, asset data information of the full-chain mapping asset being the same as asset data information of the target full-chain asset.

The cross-chain asset reconstruction transaction carries a to-be-airdropped full-chain token, and the to-be-airdropped full-chain token is a first blockchain token obtained by the first blockchain node for the to-be-transferred full-chain asset by using a full-chain token airdrop contract on the first blockchain.

The mapping asset generation module 22 is further configured to:
invoke a full-chain token airdrop contract on the second blockchain by using the target remote full-chain service contract, to determine a second blockchain airdrop token corresponding to the to-be-airdropped full-chain token, and allocate the second blockchain airdrop token to a service object corresponding to the full-chain mapping asset, where the second blockchain airdrop token is used to support the service object corresponding to the full-chain mapping asset, to perform a service operation on the full-chain mapping asset on the second blockchain.

The reconstruction transaction obtaining module 21 further includes:
a contract update unit 211, configured to obtain a contract update request that is sent by a second service object for the target remote full-chain service contract, perform contract update processing on the target remote full-chain service contract based on the contract update request, and set a contract status of the target remote full-chain service contract to a contract update status, where the second service object is a service object that is on the second blockchain and that corresponds to the target remote full-chain service contract;
a contract address obtaining unit 212, configured to obtain a target contract address that corresponds to the to-be-locked target full-chain service contract and that is on the first blockchain when detecting that the target remote full-chain service contract is in the contract update status; and
an address locking unit 213, configured to determine, in the target remote full-chain service contract by using a remote contract address locking mechanism associated with the target remote full-chain service contract, a remote contract address locking method for performing remote address locking on the target contract address, invoke the remote contract address locking method to perform remote address locking on the target contract address, and configure an address status of the target contract address after the remote address locking as an address locked status in the target remote full-chain service contract, where the target contract address in the address locked status suspends receiving a full-chain asset for cross-chain transfer that is sent by using the updated target remote full-chain service contract.

The reconstruction transaction obtaining module 21 further includes:
a locking request sending unit 214, configured to generate a contract locking request that is sent for the target remote full-chain service contract deployed on the second blockchain, and send the contract locking request to the first blockchain node, so that the first blockchain node performs remote address locking on the target remote contract address of the target remote full-chain service contract in the target full-chain service contract deployed on the first blockchain.

The reconstruction transaction obtaining module 21 further includes:
the contract update unit 211, further configured to use the target remote full-chain service contract in a contract update completion status as the updated target remote full-chain service contract when it is detected that a contract status of the target remote full-chain service contract is adjusted from the contract update status to the contract update completion status;
the contract address obtaining unit 212, further configured to obtain a target contract address that corresponds to the to-be-locked target full-chain service contract and that is on the first blockchain; and
the address locking unit 213, further configured to determine, in the updated target remote full-chain service contract by using a remote contract address locking mechanism associated with the updated target remote full-chain service contract, a remote contract address locking method for performing remote address locking on the target contract address, invoke the remote contract address locking method to perform remote address locking on the target contract address, and configure an address status of the target contract address after the remote address locking as an address locked status in the updated target remote full-chain service contract, where the target contract address in the address locked status suspends receiving a full-chain asset for cross-chain transfer that is sent by using the updated target remote full-chain service contract.

The reconstruction transaction obtaining module 21 further includes:
a locking request sending unit 214, configured to obtain a second contract binding request that is sent by the second service object for the updated target remote full-chain service contract, and obtain, from the second contract binding request, the target contract address corresponding to the to-be-bound target full-chain service contract on the first blockchain; and
a contract address binding unit 215, configured to invoke a remote address setting interface by using the full-chain contract protocol in the target remote full-chain service contract, to set the target contract address as the remote contract address bound to the updated target remote full-chain service contract.

The reconstruction transaction obtaining module 21 further includes:
a binding request sending unit 216, configured to generate a first contract binding request that is sent by the second service object for the updated target remote full-chain service contract deployed on the second blockchain, and send the first contract binding request to the first blockchain node, so that the first blockchain node performs, in the target full-chain service contract deployed on the first blockchain, remote address binding on the updated target remote contract address corresponding to the updated target remote full-chain service contract.

The reconstruction transaction obtaining module 21 further includes:
an unlocking address obtaining unit 217, configured to obtain a second contract unlocking request that is sent by the second service object for the updated target remote full-chain service contract, and obtain, from the second contract unlocking request, the target contract address corresponding to the to-be-unlocked target full-chain service contract on the first blockchain; and
a contract address unlocking unit 218, configured to determine, in the updated target remote full-chain service contract by using a remote contract address unlocking mechanism associated with the updated target remote full-chain service contract, a remote contract address unlocking method for performing remote address unlocking on the target contract address, invoke the remote contract address unlocking method to perform remote address unlocking on the target contract address corresponding to the target full-chain service contract, and configure an address status of the target contract address after the remote address unlocking as an address unlocked status in the updated target remote full-chain service contract, where the target contract address in the address unlocked status restarts receiving a full-chain asset for cross-chain transfer that is sent by using the updated target remote full-chain service contract.

The reconstruction transaction obtaining module 21 further includes:
an unlocking request sending unit 219, configured to generate a first contract unlocking request that is sent by the second service object for the updated target remote full-chain service contract deployed on the second blockchain, and send the first contract unlocking request to the first blockchain node, so that the first blockchain node performs, in the target full-chain service contract deployed on the first blockchain, remote address unlocking on the updated target remote contract address corresponding to the updated target remote full-chain service contract.

Specific implementations of the reconstruction transaction obtaining module 21 and the mapping asset generation module 22 can be found in the related descriptions of the above embodiments. Details are not described herein again. The descriptions of beneficial effects obtained by using the same method are not described herein in detail again.

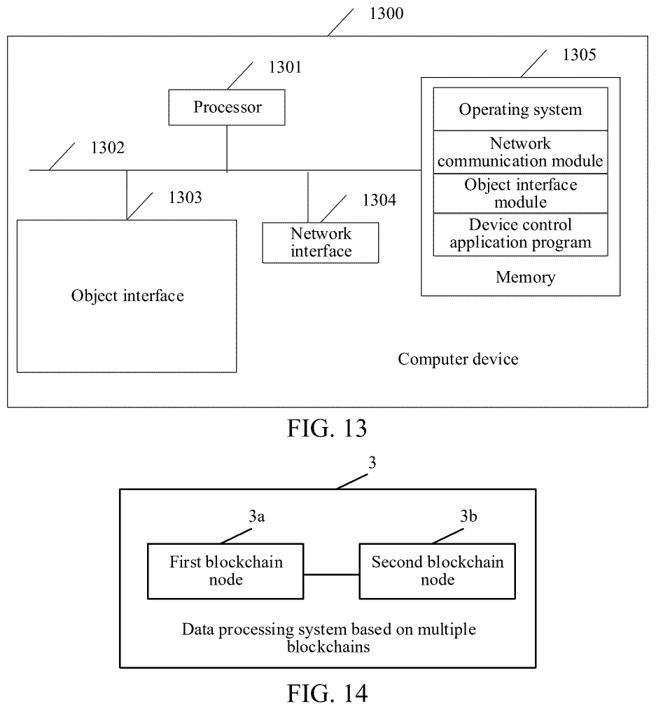

Further, FIG. 13 is a schematic structural diagram of a computer device according to an embodiment of this disclosure. As shown in FIG. 13, a computer device 1300 may be an object terminal or a server. This is not limited herein. For ease of understanding, in this disclosure, that the computer device is an object terminal is used as an example, and the computer device 1300 may include: a processor 1301, a network interface 1304, and a memory 1305. In addition, the computer device 1300 may further include: an object interface 1303 and at least one communication bus 1302. The communication bus 1302 is configured to implement connection and communication between these components. The object interface 1303 may further include a standard wired interface and wireless interface. The network interface 1304 may include a standard wired interface and wireless interface (for example, a WiFi interface) in some embodiments. The memory 1305 may be a high-speed RAM memory, or may be a non-volatile memory, for example, at least one magnetic disk memory. In some embodiments, the memory 1305 may alternatively be at least one storage apparatus away from the processor 1301. As shown in FIG. 13, as a computer-readable storage medium, the memory 1305 may include an operating system, a network communication module, an object interface module, and a device control application program.

For example, the network interface 1304 in the computer device 1300 may further provide a network data interaction function. In the computer device 1300 shown in FIG. 13, the network interface 1304 may provide a network data interaction function. The object interface 1303 is mainly configured to provide an input interface for a service object. The processor 1301 may be configured to invoke the device control application program stored in the memory 1305 to perform the descriptions of the data processing method based on multiple blockchains in the embodiment corresponding to FIG. 3 or FIG. 4, and may further perform the descriptions of the data processing apparatus 1 based on multiple blockchains in the embodiment corresponding to FIG. 13. Details are not described herein again. In addition, the description of beneficial effects of the same method are not described herein again.

In a possible implementation, the memory 1305 is configured to store program instructions. The processor 1301 may invoke the program instructions to perform the following operations:
obtaining a full-chain asset transfer request sent by a first service object for a service transaction, invoking a target full-chain service contract on the first blockchain when it is determined, based on the full-chain asset transfer request, that the service transaction is a cross-chain asset transfer transaction, and using a full-chain asset associated with the cross-chain asset transfer transaction as a to-be-transferred full-chain asset, the cross-chain asset transfer transaction being used to instruct to transfer the to-be-transferred full-chain asset from the first blockchain to the second blockchain;
invoking a full-chain contract protocol in a target full-chain service contract, to determine a target remote contract address bound to the target full-chain service contract; the full-chain contract protocol being determined based on a full-chain contract protocol interface provided by a full-chain service parent contract on the first blockchain, and a target remote full-chain service contract corresponding to the target remote contract address being a full-chain service contract that is on the second blockchain and integrated with the full-chain contract protocol; and
transmitting, by using an off-chain cross-chain service device, a cross-chain asset reconstruction transaction corresponding to a cross-chain asset transfer event to a second blockchain node in the second blockchain network when generating, based on the target remote contract address and the to-be-transferred full-chain asset, the cross-chain asset transfer event corresponding to the cross-chain asset transfer transaction, so that the second blockchain node determines, on the second blockchain based on the cross-chain asset reconstruction transaction, the target remote full-chain service contract corresponding to the target remote contract address, and invokes the target remote full-chain service contract to generate, on the second blockchain, a full-chain mapping asset corresponding to the to-be-transferred full-chain asset, asset data information of the full-chain mapping asset being the same as asset data information of the to-be-transferred full-chain resource.

The cross-chain asset transfer transaction carries a second blockchain identifier of the second blockchain.

When invoking a full-chain contract protocol in a target full-chain service contract, to determine a target remote contract address bound to the target full-chain service contract, the processor 1301 is specifically configured to:
invoke a full-chain contract protocol in the target full-chain service contract, to obtain a remote contract address bound to the target full-chain service contract; where the remote contract address bound to the target full-chain service contract includes a contract address corresponding to a full-chain service contract that is on a reference service chain and integrated with the full-chain contract protocol; the reference service chain is a blockchain of the multiple blockchains other than the first blockchain; and the reference service chain includes the second blockchain; and
determine a remote contract address associated with the second blockchain identifier as the target remote contract address in the remote contract address bound to the target full-chain service contract.

When generating, based on the target remote contract address and the to-be-transferred full-chain asset, the cross-chain asset transfer event corresponding to the cross-chain asset transfer transaction, the processor 1301 is specifically configured to:
invoke the target full-chain service contract to switch an asset status of the to-be-transferred full-chain asset from a first status to a second status, where the second status is an asset locked status; and
when the asset status of the to-be-transferred full-chain asset is the second status, generate, based on the target remote contract address and the to-be-transferred full-chain asset, the cross-chain asset transfer event corresponding to the cross-chain asset transfer transaction.

When generating, based on the target remote contract address and the to-be-transferred full-chain asset, the cross-chain asset transfer event corresponding to the cross-chain asset transfer transaction, the processor 1301 is specifically configured to:
obtain a first blockchain identifier of the first blockchain; where the first blockchain identifier is a blockchain identifier configured for the first blockchain through a unified full-chain registration service in an off-chain full-chain cross-chain service;
invoke a full-chain event identifier generation protocol in the full-chain service contract based on the first blockchain identifier, to generate an event identifier associated with the first blockchain identifier; and
generate, based on the event identifier, the target remote contract address, and the to-be-transferred full-chain asset, the cross-chain asset transfer event corresponding to the cross-chain asset transfer transaction.

The cross-chain asset transfer event carries an asset identifier of the to-be-transferred full-chain asset, and the asset identifier of the to-be-transferred full-chain asset is generated based on an identifier prefix associated with the first blockchain and an asset identifier template configured in the full-chain contract protocol. The cross-chain asset reconstruction transaction corresponding to the cross-chain asset transfer event is constructed when the off-chain cross-chain service device performs, based on the identifier prefix and the asset identifier template, identifier verification on the asset identifier of the to-be-transferred full-chain asset carried in the cross-chain asset transfer event and succeeds in the identifier verification.

Before generating the cross-chain asset transfer event corresponding to the cross-chain asset transfer transaction, the processor 1301 is further configured to:
invoke a full-chain token airdrop contract on the first blockchain by using the target full-chain service contract, to obtain a first blockchain token associated with the to-be-transferred full-chain asset, and use the obtained first blockchain token as a to-be-airdropped full-chain token; and
write the to-be-airdropped full-chain token into a cross-chain token transfer event when generating the cross-chain token transfer event corresponding to a cross-chain token transfer transaction.

The to-be-transferred full-chain asset is some or all of full-chain assets for cross-chain transfer determined on the first blockchain.

The processor 1301 is further configured to:
obtain a full-chain asset determining request for a full-chain asset determining transaction, invoke the target full-chain service contract on the first blockchain based on the full-chain asset determining request, and determine a determined asset quantity of the full-chain asset determining transaction as a to-be-determined asset quantity;
invoke the full-chain contract protocol in the target full-chain service contract, to obtain the identifier prefix associated with the first blockchain, and generate, based on the identifier prefix associated with the first blockchain and the asset identifier template configured in the full-chain contract protocol, a to-be-determined full-chain asset identifier corresponding to the to-be-determined asset quantity, where the to-be-determined full-chain asset identifier includes the identifier prefix associated with the first blockchain; and
invoke an asset determining contract in the target full-chain service contract, to determine, on the first blockchain, a full-chain asset corresponding to the to-be-determined full-chain asset identifier, and use the determined full-chain asset as a full-chain asset for cross-chain transfer determined on the first blockchain.

When the contract status of the target remote full-chain service contract is the contract update status, the processor 1301 is further configured to:
obtain a contract locking request sent by a second service object for a target remote full-chain service contract deployed on a second blockchain; where the second service object is a service object that is on the second blockchain and that corresponds to the target remote full-chain service contract, and the contract locking request is generated after the second service object performs, in the target remote full-chain service contract deployed on the second blockchain, remote address locking on a contract address corresponding to the target full-chain service contract;
obtain, from the contract locking request, a target remote contract address corresponding to the to-be-locked target remote full-chain service contract on the second blockchain; and
determine, in the target full-chain service contract by using a remote contract address locking mechanism associated with the target full-chain service contract, a remote contract address locking method for performing remote address locking on the target remote contract address, invoke the remote contract address locking method to perform remote address locking on the target remote contract address corresponding to the target remote full-chain service contract, and configure an address status of the target remote contract address after the remote address locking as an address locked status in the target full-chain service contract, where the target remote contract address in the address locked status suspends receiving a full-chain asset for cross-chain transfer that is sent by the first service object by using the target full-chain service contract.

The target remote full-chain service contract in a contract update completion status is the updated target remote full-chain service contract when a contract status of the target remote full-chain service contract is adjusted from the contract update status to the contract update completion status. A contract address of the updated target remote full-chain service contract is the updated target remote contract address.

The processor 1301 is further configured to:
obtain a first contract binding request sent by the second service object for the updated target remote full-chain service contract deployed on the second blockchain; where the first contract binding request is generated after the second service object performs remote address binding on the target contract address in the updated target remote full-chain service contract deployed on the second blockchain;
obtain, from the first contract binding request, the updated target remote contract address corresponding to the to-be-bound updated target remote full-chain service contract on the second blockchain; and
invoke a remote address setting interface by using the full-chain contract protocol in the target full-chain service contract, to set the updated target remote contract address as the remote contract address bound to the target full-chain service contract.

The processor 1301 is further configured to:
obtain a first contract unlocking request sent by the second service object for the updated target remote full-chain service contract deployed on the second blockchain; where the first contract unlocking request is generated after the second service object performs remote address unlocking on the target contract address in the updated target remote full-chain service contract deployed on the second blockchain;
obtain, from the first contract unlocking request, the updated target remote contract address corresponding to the to-be-unlocked updated target remote full-chain service contract on the second blockchain; and
determine, in the target full-chain service contract by using a remote contract address unlocking mechanism associated with the target full-chain service contract, a remote contract address unlocking method for performing remote address unlocking on the updated target remote contract address, invoke the remote contract address unlocking method to perform remote address unlocking on the updated target remote contract address corresponding to the updated target remote full-chain service contract, and configure an address status of the updated target remote contract address after the remote address unlocking as an address unlocked status in the target full-chain service contract, where the updated target remote contract address in the address unlocked status restarts receiving a full-chain asset for cross-chain transfer that is sent by the first service object by using the target full-chain service contract.

The processor 1301 is further configured to:
when determining that the remote contract address bound to the target full-chain service contract is updated, use, as an updated remote contract address, an updated target remote contract address to which the remote contract address bound to the target full-chain service contract is updated;
invoke a key information disclosing interface by using the full-chain contract protocol in the target full-chain service contract, to obtain node port information associated with the updated remote contract address; and
perform, by using an information management and verification service in an off-chain full-chain cross-chain service, security verification on the node port information associated with the updated remote contract address.

The processor 1301 is further configured to:
read, by using an off-chain cross-chain service device, the cross-chain asset transfer event that is associated with the target full-chain service contract and that is generated in a target cycle, where when reading a cross-chain asset transfer event associated with the target full-chain service contract, the off-chain cross-chain service device is configured to perform event verification on the cross-chain asset transfer event by using the cross-chain event verification and forwarding service in the off-chain full-chain cross-chain service, and for the cross-chain asset transfer event for which the event verification succeeds, forward a cross-chain asset reconstruction transaction corresponding to the cross-chain asset transfer event.

In a possible implementation, the memory 1305 is configured to store program instructions. The processor 1301 may invoke the program instructions to perform the following operations:
obtaining a cross-chain asset reconstruction transaction, the cross-chain asset reconstruction transaction corresponding to a cross-chain asset transfer event, the cross-chain asset transfer event being sent by a first blockchain node in the first blockchain network by using an off-chain cross-chain service device, the cross-chain asset transfer event being an event that corresponds to a cross-chain asset transfer transaction and that is generated by the first blockchain node based on a target remote contract address bound to a target full-chain service contract and a to-be-transferred full-chain asset, the target remote contract address being obtained by the first blockchain node by using a full-chain contract protocol in the target full-chain service contract, the to-be-transferred full-chain asset being a full-chain asset that is associated with the cross-chain asset transfer transaction and that is determined by invoking the target full-chain service contract when the first blockchain node obtains a full-chain asset transfer request sent by a first service object for a service transaction and determines, based on the full-chain asset transfer request, that the service transaction is a cross-chain asset transfer transaction, the target full-chain service contract being a full-chain service contract that is on the first blockchain and integrated with the full-chain contract protocol, and a remote full-chain service contract corresponding to the target remote contract address being a full-chain service contract that is on the second blockchain and integrated with the full-chain contract protocol; and
determining, on the second blockchain based on the cross-chain asset reconstruction transaction, the target remote full-chain service contract corresponding to the target remote contract address, and invoking the target remote full-chain service contract to generate, on the second blockchain, a full-chain mapping asset corresponding to the to-be-transferred full-chain asset, asset data information of the full-chain mapping asset being the same as asset data information of the target full-chain asset.

The cross-chain asset reconstruction transaction carries a to-be-airdropped full-chain token, and the to-be-airdropped full-chain token is a first blockchain token obtained by the first blockchain node for the to-be-transferred full-chain asset by using a full-chain token airdrop contract on the first blockchain.

When invoking the target remote full-chain service contract to generate, on the second blockchain, a full-chain mapping asset corresponding to the to-be-transferred full-chain asset, the processor 1301 is further configured to:
invoke a full-chain token airdrop contract on the second blockchain by using the target remote full-chain service contract, to determine a second blockchain airdrop token corresponding to the to-be-airdropped full-chain token, and allocate the second blockchain airdrop token to a service object corresponding to the full-chain mapping asset, where the second blockchain airdrop token is used to support the service object corresponding to the full-chain mapping asset, to perform a service operation on the full-chain mapping asset on the second blockchain.

The processor 1301 is further configured to:
obtain a contract update request that is sent by a second service object for the target remote full-chain service contract, perform contract update processing on the target remote full-chain service contract based on the contract update request, and set a contract status of the target remote full-chain service contract to a contract update status, where the second service object is a service object that is on the second blockchain and that corresponds to the target remote full-chain service contract,
obtain a target contract address that corresponds to the to-be-locked target full-chain service contract and that is on the first blockchain when detecting that the target remote full-chain service contract is in the contract update status; and
determine, in the target remote full-chain service contract by using a remote contract address locking mechanism associated with the target remote full-chain service contract, a remote contract address locking method for performing remote address locking on the target contract address, invoke the remote contract address locking method to perform remote address locking on the target contract address, and configure an address status of the target contract address after the remote address locking as an address locked status in the target remote full-chain service contract, where the target contract address in the address locked status suspends receiving a full-chain asset for cross-chain transfer that is sent by using the updated target remote full-chain service contract.

The processor 1301 is further configured to:
generate a contract locking request that is sent for the target remote full-chain service contract deployed on the second blockchain, and send the contract locking request to the first blockchain node, so that the first blockchain node performs remote address locking on the target remote contract address of the target remote full-chain service contract in the target full-chain service contract deployed on the first blockchain.

The processor 1301 is further configured to:
use the target remote full-chain service contract in a contract update completion status as the updated target remote full-chain service contract when it is detected that a contract status of the target remote full-chain service contract is adjusted from the contract update status to the contract update completion status;
obtain a target contract address that corresponds to the to-be-locked target full-chain service contract and that is on the first blockchain; and
determine, in the updated target remote full-chain service contract by using a remote contract address locking mechanism associated with the updated target remote full-chain service contract, a remote contract address locking method for performing remote address locking on the target contract address, invoke the remote contract address locking method to perform remote address locking on the target contract address, and configure an address status of the target contract address after the remote address locking as an address locked status in the updated target remote full-chain service contract, where the target contract address in the address locked status suspends receiving a full-chain asset for cross-chain transfer that is sent by using the updated target remote full-chain service contract.

A contract address corresponding to the updated target remote full-chain service contract is the updated target remote contract address.

The processor 1301 is further configured to:
obtain a second contract binding request that is sent by the second service object for the updated target remote full-chain service contract, and obtain, from the second contract binding request, the target contract address corresponding to the to-be-bound target full-chain service contract on the first blockchain; and
invoke a remote address setting interface by using the full-chain contract protocol in the target remote full-chain service contract, to set the target contract address as the remote contract address bound to the updated target remote full-chain service contract.

The processor 1301 is further configured to:
generate a first contract binding request that is sent by the second service object for the updated target remote full-chain service contract deployed on the second blockchain, and send the first contract binding request to the first blockchain node, so that the first blockchain node performs, in the target full-chain service contract deployed on the first blockchain, remote address binding on the updated target remote contract address corresponding to the updated target remote full-chain service contract.

The processor 1301 is further configured to:
obtain a second contract unlocking request that is sent by the second service object for the updated target remote full-chain service contract, and obtain, from the second contract unlocking request, the target contract address corresponding to the to-be-unlocked target full-chain service contract on the first blockchain; and
determine, in the updated target remote full-chain service contract by using a remote contract address unlocking mechanism associated with the updated target remote full-chain service contract, a remote contract address unlocking method for performing remote address unlocking on the target contract address, invoke the remote contract address unlocking method to perform remote address unlocking on the target contract address corresponding to the target full-chain service contract, and configure an address status of the target contract address after the remote address unlocking as an address unlocked status in the updated target remote full-chain service contract, where the target contract address in the address unlocked status restarts receiving a full-chain asset for cross-chain transfer that is sent by using the updated target remote full-chain service contract.

The processor 1301 is further configured to:
generate a first contract unlocking request that is sent by the second service object for the updated target remote full-chain service contract deployed on the second blockchain, and send the first contract unlocking request to the first blockchain node, so that the first blockchain node performs, in the target full-chain service contract deployed on the first blockchain, remote address unlocking on the updated target remote contract address corresponding to the updated target remote full-chain service contract.

During specific implementation, the apparatus, the processor 1301, the memory 1305, and the like described in this embodiment of this disclosure may perform the implementations described in the foregoing method embodiments, and may also perform the implementations described in this embodiment of this disclosure. Details are not described herein again.

Besides, the embodiments of this disclosure further provide a computer-readable storage medium. The computer-readable storage medium stores computer-readable instructions executed by the data processing apparatus 1 based on multiple blockchains and the data processing apparatus 2 based on multiple blockchains. When executing the computer-readable instructions, the processor can perform the descriptions of the data processing method based on multiple blockchains in the embodiments corresponding to FIG. 4, FIG. 6, and FIG. 8. Therefore, details are not described herein again. In addition, the description of beneficial effects of the same method are not described herein again. For technical details that are not disclosed in the embodiments of the computer-readable storage medium included in this disclosure, reference may be made to the descriptions about the method embodiments of this disclosure. As an example, the computer-readable instructions may be deployed to be executed on one computing device, or deployed to be executed on multiple computing devices in the same location, or deployed to be executed on multiple computing devices that are distributed in multiple locations and interconnected by using a communication network. The multiple computing devices that are distributed in the multiple locations and interconnected by using the communication network may form a blockchain system.

Further, FIG. 14 is a schematic diagram of a data processing system based on multiple blockchains according to an embodiment of this disclosure. A data processing system 3 based on multiple blockchains may include a first blockchain node 3a and a second blockchain node 3b. The first blockchain node 3a may be a blockchain node in the first blockchain network described in the foregoing embodiment. For example, the first blockchain node 3a may be any blockchain node in the first blockchain network 200 shown in FIG. 1. Details are not described herein again. The second blockchain node 3b may be a blockchain node in the second blockchain network described in the foregoing embodiment. For example, the second blockchain node 3b may be any blockchain node in the second blockchain network 300 shown in FIG. 1. Details are not described herein again. In addition, the description of beneficial effects of the same method are not described herein again.

Besides, an embodiment of this disclosure further provides a computer program product or a computer program, including computer-readable instructions that may be stored in a computer-readable storage medium. A processor of a computer device reads the computer-readable instructions from the computer-readable storage medium, and the processor may execute the computer-readable instructions, so that the computer device implements the foregoing descriptions of the data processing method based on multiple blockchains in the embodiments corresponding to FIG. 4, FIG. 6, and FIG. 8. Therefore, details are not repeated herein. In addition, the description of beneficial effects of the same method are not described herein again. For the technical details not disclosed in the embodiment of the computer program product or the computer program in this disclosure, refer to the description of the method embodiments of this disclosure.

To simplify the description, the foregoing method embodiments are described as a series of action combinations, but a person skilled in the art know that this disclosure is not limited to any described sequence of the actions, as some operations can be executed in other sequences or simultaneously according to this disclosure. In addition, a person skilled in the art also knows that all the embodiments described in the specification are preferred embodiments, and the related actions and modules are not necessarily mandatory to this disclosure.

The operations in the method of the embodiments of this disclosure can be sequentially adjusted, merged and deleted according to actual needs.

The modules in the apparatus of the embodiments of this disclosure can be merged, divided and deleted according to actual needs.

A person of ordinary skill in the art can understand that all or some of the processes of the methods in the foregoing embodiments may be implemented by computer-readable instructions instructing relevant hardware. The computer-readable instructions may be stored in a computer-readable storage medium. When the program is executed, the processes in the foregoing method embodiments may be included. The storage medium may be a magnetic disc, an optical disc, a read-only memory (ROM), or a random access memory (RAM).

What is disclosed above is merely exemplary embodiments of this disclosure, and certainly is not intended to limit the scope of the claims of this disclosure. Therefore, equivalent variations made in accordance with the claims of this disclosure shall fall within the scope of this disclosure.

Technical features of the foregoing embodiments may be combined in any manner. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this disclosure, which are described specifically and in detail, but cannot be construed as a limitation to the patent scope of this disclosure. For a person of ordinary skill in the art, several transformations and improvements can be made without departing from the idea of this disclosure. These transformations and improvements belong to the protection scope of this disclosure. Therefore, the protection scope of the patent of this disclosure shall be subject to the appended claims.

What is claimed is:

1. A data processing method for multiple blockchains, wherein the multiple blockchains comprise a first blockchain and a second blockchain, the first blockchain corresponds to a first blockchain network with a first blockchain node, the second blockchain corresponds to a second blockchain network, the first blockchain network is independent of the second blockchain network, and the method, performed by a computer device comprising:
obtaining a full-chain asset transfer request sent by a first service object for a service transaction;
invoking a target full-chain service contract on the first blockchain, wherein the service transaction is a cross-chain asset transfer transaction;
using a full-chain asset associated with the cross-chain asset transfer transaction as a to-be-transferred full-chain asset;
invoking a full-chain contract protocol in the target full-chain service contract to determine a target remote contract address bound to the target full-chain service contract, wherein a full-chain contract protocol interface of a full-chain service parent contract on the first blockchain and a target remote full-chain service contract on the second blockchain determine the full-chain contract protocol;
transmitting, with an off-chain cross-chain service device, a cross-chain asset reconstruction transaction corresponding to a cross-chain asset transfer event to a second blockchain node in the second blockchain network, when generating, based on the target remote contract address and the to-be-transferred full-chain asset, the cross-chain asset transfer event corresponding to the cross-chain asset transfer transaction;
determining, with a second blockchain node on the second blockchain, based on the cross-chain asset reconstruction transaction, the target remote full-chain service contract corresponding to the target remote contract address; and
invoking the target remote full-chain service contract to generate, on the second blockchain, a full-chain mapping asset corresponding to the to-be-transferred full-chain asset.

2. The method according to claim 1, wherein the cross-chain asset transfer transaction carries a second blockchain identifier of the second blockchain; and
the invoking the full-chain contract protocol in the target full-chain service contract, to determine a target remote contract address bound to the target full-chain service contract comprises:
invoking the full-chain contract protocol in the target full-chain service contract, to obtain a remote contract address bound to the target full-chain service contract, wherein the remote contract address bound to the target full-chain service contract comprises a contract address corresponding to a full-chain service contract that is on a reference service chain and integrated with the full-chain contract protocol, wherein the reference service chain is a blockchain other than the first blockchain and comprises at least the second blockchain; and
determining, in the remote contract address bound to the target full-chain service contract, a remote contract address associated with the second blockchain identifier as the target remote contract address.

3. The method according to claim 1, wherein the generating, based on the target remote contract address and the to-be-transferred full-chain asset, the cross-chain asset transfer event corresponding to the cross-chain asset transfer transaction comprises:
obtaining a first blockchain identifier of the first blockchain, wherein the first blockchain identifier is configured for the first blockchain through a unified full-chain registration service in an off-chain full-chain cross-chain service;
invoking a full-chain event identifier generation protocol in a full-chain service contract based on the first blockchain identifier, to generate an event identifier associated with the first blockchain identifier; and
generating, based on the event identifier, the target remote contract address and the to-be-transferred full-chain asset, wherein the cross-chain asset transfer event corresponds to the cross-chain asset transfer transaction.

4. The method according to claim 1, wherein the cross-chain asset transfer event carries an asset identifier of the to-be-transferred full-chain asset,
wherein the asset identifier of the to-be-transferred full-chain asset is generated based on an identifier prefix associated with the first blockchain and an asset identifier template configured in the full-chain contract protocol, and the cross-chain asset reconstruction transaction corresponding to the cross-chain asset transfer event is constructed when the off-chain cross-chain service device successfully verifies the asset identifier of the to-be-transferred full-chain asset, based on the identifier prefix and the asset identifier template.

5. The method according to claim 1, wherein before generating the cross-chain asset transfer event corresponding to the cross-chain asset transfer transaction, the method further comprises:
invoking a full-chain token airdrop contract on the first blockchain by using the target full-chain service contract to obtain a first blockchain token associated with the to-be-transferred full-chain asset;
determining a to-be-airdropped full-chain token based on the first blockchain token as a to-be-airdropped full-chain token; and
writing the to-be-airdropped full-chain token into the cross-chain asset transfer event when generating the cross-chain asset transfer event.

6. The method according to claim 1, wherein when a contract status of the target remote full-chain service contract is a contract update status, the method further comprises:
obtaining a contract locking request from a second service object for the target remote full-chain service contract deployed on the second blockchain, wherein the second service object corresponds to the target remote full-chain service contract, after the second service object performs, in the target remote full-chain service contract deployed on the second blockchain, remote address locking on a contract address corresponding to the target full-chain service contract;
obtaining, from the contract locking request, the target remote contract address corresponding to a to-be-locked target remote full-chain service contract on the second blockchain; and
determining, in the target full-chain service contract with a remote contract address locking mechanism associated with the target full-chain service contract, a remote contract address locking protocol for the target remote contract address;
locking the target remote contract address with the remote contract address locking protocol; and
configuring an address status of the target remote contract address as an address locked status in the target full-chain service contract, wherein the target remote contract address in the address locked status suspends receiving a full-chain asset for cross-chain transfer sent by the first service object with the target full-chain service contract.

7. The method according to claim 6, wherein when the contract status of the target remote full-chain service contract is adjusted from the contract update status to a contract update completion status, the target remote full-chain service contract in the contract update completion status is an updated target remote full-chain service contract, and a contract address of the updated target remote full-chain service contract is an updated target remote contract address; and
the method further comprises:
obtaining a first contract binding request sent by the second service object for the updated target remote full-chain service contract deployed on the second blockchain, wherein the first contract binding request is generated after the second service object performs remote address binding on the updated target remote contract address in the updated target remote full-chain service contract deployed on the second blockchain;
obtaining, from the first contract binding request, the updated target remote contract address corresponding to the updated target remote full-chain service contract on the second blockchain; and
invoking a remote address setting interface with the full-chain contract protocol in the target full-chain service contract to set the target remote contract address as the remote contract address bound to the target full-chain service contract.

8. The method according to claim 7, further comprising:
obtaining a first contract unlocking request that is sent by the second service object for the updated target remote full-chain service contract deployed on the second blockchain, wherein the first contract unlocking request is generated after the second service object performs remote address unlocking on the target contract address in the updated target remote full-chain service contract deployed on the second blockchain;
obtaining, from the first contract unlocking request, the updated target remote contract address corresponding to the updated target remote full-chain service contract on the second blockchain;
determining, in the target full-chain service contract, with a remote contract address unlocking mechanism associated with the target full-chain service contract, a remote contract address unlocking protocol for performing remote address unlocking on the updated target remote contract address;
unlocking the updated target remote contract address; and
configuring an address status of the updated target remote contract address as an address unlocked status in the target full-chain service contract, wherein the updated target remote contract address in the address unlocked status restarts receiving a full-chain asset for cross-chain transfer sent by the first service object with the target full-chain service contract.

9. A data processing method for multiple blockchains, wherein the multiple blockchains comprise a first blockchain and a second blockchain, the first blockchain corresponds to a first blockchain network, the second blockchain corresponds to a second blockchain network, the second blockchain network is independent of the first blockchain network, and the method is performed by a computer device maintaining a second blockchain node in the second blockchain network, and comprising:
obtaining a cross-chain asset reconstruction transaction, wherein the cross-chain asset reconstruction transaction corresponds to a cross-chain asset transfer event sent by a first blockchain node in the first blockchain network that corresponds to a cross-chain asset transfer transaction that was generated by the first blockchain node based on a target remote contract address bound to a target remote full-chain service contract and a to-be-transferred full-chain asset; and
determining, on the second blockchain based on the cross-chain asset reconstruction transaction, the target remote full-chain service contract corresponding to the target remote contract address, and invoking the target remote full-chain service contract to generate, on the second blockchain, a full-chain mapping asset corresponding to the to-be-transferred full-chain asset.

10. The method according to claim 9, wherein the cross-chain asset reconstruction transaction carries a to-be-airdropped full-chain token, and the to-be-airdropped full-chain token is a first blockchain token obtained by the first blockchain node for the to-be-transferred full-chain asset by using a full-chain token airdrop contract on the first blockchain; and
when invoking the target remote full-chain service contract to generate, on the second blockchain, a full-chain mapping asset corresponding to the to-be-transferred full-chain asset, the method further comprises:
invoking a full-chain token airdrop contract on the second blockchain with the target remote full-chain service contract to determine a second blockchain airdrop token that corresponds to the to-be-airdropped full-chain token; and
allocating the second blockchain airdrop token to a service object corresponding to the full-chain mapping asset, wherein the second blockchain airdrop token is used to support the service object corresponding to the full-chain mapping asset to perform a service operation on the full-chain mapping asset on the second blockchain.

11. The method according to claim 10, further comprising:
obtaining a contract update request sent by a second service object for the target remote full-chain service contract, wherein the second service object is a service object that is on the second blockchain and that corresponds to the target remote full-chain service contract;
performing contract update processing on the target remote full-chain service contract based on the contract update request;
setting a contract status of the target remote full-chain service contract to a contract update status;
obtaining a target contract address that corresponds to a to-be-locked target full-chain service contract and is on the first blockchain, when detecting that the target remote full-chain service contract is in the contract update status; and
determining, in the target remote full-chain service contract by using a remote contract address locking mechanism associated with the target remote full-chain service contract, a remote contract address locking protocol for performing remote address locking on the target contract address;
locking the target contract address with the remote contract address locking protocol; and
configuring an address status of the target contract address after the remote address locking as an address locked status in the target remote full-chain service contract, wherein the target contract address in the address locked status suspends receiving a full-chain asset for cross-chain transfer sent with the target remote full-chain service contract.

12. The method according to claim 11, further comprising:
generating a contract locking request that is sent for the target remote full-chain service contract deployed on the second blockchain;
transmitting the contract locking request to the first blockchain node;
performing, by the first blockchain node, remote address locking on the target remote contract address of the target remote full-chain service contract in the target full-chain service contract deployed on the first blockchain.

13. The method according to claim 12, further comprising:
using the target remote full-chain service contract in a contract update completion status as an updated target remote full-chain service contract when detecting that a contract status of the target remote full-chain service contract is adjusted from the contract update status to the contract update completion status;
obtaining a target contract address that corresponds to the to-be-locked target full-chain service contract and that is on the first blockchain; and
determining, in the updated target remote full-chain service contract with a remote contract address locking mechanism associated with the updated target remote full-chain service contract, a remote contract address locking protocol for performing remote address locking on the target contract address;
invoking the remote contract address locking protocol to perform remote address locking on the target contract address; and
configuring an address status of the target contract address after the remote address locking as an address locked status in the updated target remote full-chain service contract, wherein the target contract address in the address locked status suspends receiving a full-chain asset for cross-chain transfer that is sent with the updated target remote full-chain service contract.

14. The method according to claim 13, wherein a contract address corresponding to the updated target remote full-chain service contract is the updated target remote contract address, and the method further comprises:
obtaining a second contract binding request that is sent by the second service object for the updated target remote full-chain service contract;
determining, from the second contract binding request, the target contract address corresponding to a to-be-bound target full-chain service contract on the first blockchain; and
invoking a remote address setting interface by using a full-chain contract protocol in the target remote full-chain service contract to set the target contract address as the remote contract address bound to the updated target remote full-chain service contract.

15. The method according to claim 14, wherein the method further comprises:
obtaining a second contract unlocking request that is sent by the second service object for the updated target remote full-chain service contract;
obtaining, from the second contract unlocking request, the target contract address corresponding to a to-be-unlocked target full-chain service contract on the first blockchain;
determining, in the updated target remote full-chain service contract with a remote contract address unlocking mechanism associated with the updated target remote full-chain service contract, a remote contract address unlocking protocol for performing remote address unlocking on the target contract address; and
invoking the remote contract address unlocking protocol to perform remote address unlocking on the target contract address corresponding to the target full-chain service contract, and configuring an address status of the target contract address after the remote address unlocking as an address unlocked status in the updated target remote full-chain service contract, wherein the target contract address in the address unlocked status restarts receiving a full-chain asset for cross-chain transfer sent with the updated target remote full-chain service contract.

16. A data processing apparatus with at least one module based on multiple blockchains, the multiple blockchains comprising a first blockchain and a second blockchain, a blockchain network corresponding to the first blockchain being a first blockchain network, a blockchain network corresponding to the second blockchain being a second blockchain network, the first blockchain network being independent of the second blockchain network, and the apparatus being run on a first blockchain node in the first blockchain network and the at least one module configured to:
obtain a full-chain asset transfer request sent by a first service object for a service transaction;
invoke a target full-chain service contract on the first blockchain, wherein the service transaction is a cross-chain asset transfer transaction;
use a full-chain asset associated with the cross-chain asset transfer transaction as a to-be-transferred full-chain asset;
invoke a full-chain contract protocol in the target full-chain service contract to determine a target remote contract address bound to the target full-chain service contract, wherein a full-chain contract protocol interface of a full-chain service parent contract on the first blockchain and a target remote full-chain service contract on the second blockchain determine the full-chain contract protocol;
transmit, with an off-chain cross-chain service device, a cross-chain asset reconstruction transaction corresponding to a cross-chain asset transfer event to a second blockchain node in the second blockchain network, when generating, based on the target remote contract address and the to-be-transferred full-chain asset, the cross-chain asset transfer event corresponding to the cross-chain asset transfer transaction;
determine, with the second blockchain node, on the second blockchain based on the cross-chain asset reconstruction transaction, the target remote full-chain service contract corresponding to the target remote contract address; and
invoke the target remote full-chain service contract to generate, on the second blockchain, a full-chain mapping asset corresponding to the to-be-transferred full-chain asset.

17. The apparatus according to claim 16, wherein the at least one module is further configured to, when generating, based on the target remote contract address and the to-be-transferred full-chain asset, the cross-chain asset transfer event corresponding to the cross-chain asset transfer transaction:
obtain a first blockchain identifier of the first blockchain, wherein the first blockchain identifier is configured for the first blockchain through a unified full-chain registration service in an off-chain full-chain cross-chain service;
invoke a full-chain event identifier generation protocol in a full-chain service contract based on the first blockchain identifier, to generate an event identifier associated with the first blockchain identifier; and
generate, based on the event identifier, the target remote contract address and the to-be-transferred full-chain asset, wherein the cross-chain asset transfer event corresponds to the cross-chain asset transfer transaction.

18. The apparatus according to claim 16, wherein the cross-chain asset transfer event carries an asset identifier of the to-be-transferred full-chain asset,
wherein the asset identifier of the to-be-transferred full-chain asset is generated based on an identifier prefix associated with the first blockchain and an asset identifier template configured in the full-chain contract protocol, and the cross-chain asset reconstruction transaction corresponding to the cross-chain asset transfer event is constructed when the off-chain cross-chain service device successfully verifies the asset identifier of the to-be-transferred full-chain asset, based on the identifier prefix and the asset identifier template.

19. The apparatus according to claim 16, wherein before generating the cross-chain asset transfer event corresponding to the cross-chain asset transfer transaction, the apparatus is further configured to:
invoke a full-chain token airdrop contract on the first blockchain by using the target full-chain service contract to obtain a first blockchain token associated with the to-be-transferred full-chain asset;
determine a to-be-airdropped full-chain token based on the first blockchain token as a to-be-airdropped full-chain token; and write the to-be-airdropped full-chain token into the cross-chain asset transfer event when generating the cross-chain asset transfer event.

20. The apparatus according to claim 16, wherein when a contract status of the target remote full-chain service contract is a contract update status, the at least one module is further configured to: obtain a contract locking request from a second service object for the target remote full-chain service contract deployed on the second blockchain, wherein the second service object corresponds to the target remote full-chain service contract, after the second service object performs, in the target remote full-chain service contract deployed on the second blockchain, remote address locking on a contract address corresponding to the target full-chain service contract; obtain, from the contract locking request, the target remote contract address corresponding to a to-be-locked target remote full-chain service contract on the second blockchain; and determine, in the target full-chain service contract with a remote contract address locking mechanism associated with the target full-chain service contract, a remote contract address locking protocol for the target remote contract address; lock the remote contract address with the remote contract address locking protocol; and configure an address status of the target remote contract address as an address locked status in the target full-chain service contract, wherein the target remote contract address in the address locked status suspends receiving a full-chain asset for cross-chain transfer sent by the first service object with the target full-chain service contract.
